(19) United States
(12) Patent Application Publication
(10) Pub. No.: US 2013/0335390 A1
(43) Pub. Date: Dec. 19, 2013

(54) Multi-projection Display and Brightness Adjustment Method Thereof

(71) Applicants: Osamu Ishibashi, Tokyo (JP); Fujio Okumura, Tokyo (JP); Yoshiho Yanagita, Tokyo (JP); Masahiko Ohta, Tokyo (JP); So Nishimura, Tokyo (JP)

(72) Inventors: Osamu Ishibashi, Tokyo (JP); Fujio Okumura, Tokyo (JP); Yoshiho Yanagita, Tokyo (JP); Masahiko Ohta, Tokyo (JP); So Nishimura, Tokyo (JP)

(73) Assignee: NEC Corporation, Tokyo (JP)

(21) Appl. No.: 14/001,857

(22) PCT Filed: Feb. 14, 2012
(86) PCT No.: PCT/JP2012/053361

§ 371 Date: Aug. 27, 2013

(30) Foreign Application Priority Data
Mar. 3, 2011 (JP) 2011-046795

(51) Int. Cl. G09G 5/10

(52) U.S. Cl. CPC G09G 5/10
USPC 345/207

(57) ABSTRACT

A multi-projection display includes: a plurality of projector units; a plurality of optical sensors that are provided corresponding to each of the projector units; and a main control unit that both causes adjustment images to be projected by each of the projector units and vertically synchronizes each projected adjustment image. Each projector unit acquires by a respective optical sensor brightness values of the picture elements that are adjacent between the adjustment image that is projected by the projector unit and the adjustment images that are projected by other projector units and adjusts the brightness of the projected image based on the differences in the acquired brightness values.

### TECHNICAL FIELD

The present invention relates to a multi-projection display that is equipped with a plurality of projector units that each project an image onto a screen by scanning with an optical beam and that joins together the images that are projected by each of the projector units to display them as one image.

### BACKGROUND ART

Multi-projection displays are known that are equipped with a plurality of projectors and that join together the images that are projected by each of the projectors to display them as one image.

Typically, light sources that are used in projectors are subject to variation in brightness due to individual differences that arise in manufacturing. In addition, the optical output performance of a light source decreases with the length of time of use (aging). Due to these reasons, brightness may differ among the images that are projected by each projector.

When the brightness differs between adjacent images when a plurality of images are joined to form one image, the seams between these images become noticeable, with the result that display quality seriously deteriorates.

In response to this problem, multi-projection systems have been proposed that enable the matching of the brightness of the projected images of each of the projectors (see Patent Document 1).

The multi-projection system disclosed in Patent Document 1 includes a plurality of projectors, one measurement camera, a test image creation unit, an image processing unit, a seamless processing unit, a plurality of image reproduction units provided corresponding to each projector, a synchronizing control unit, and an image signal switch unit.

Each projector is arranged on the back surface side of a rear-projection screen and projects onto the rear-projection screen an image based on an image signal that is received as input. The measurement camera is arranged in front (on the observation side) of the rear-projection screen and is able to capture the whole rear-projection screen all at once. The output signal of the measurement camera is supplied to the image processing unit.

Each image reproduction unit generates an image signal for supply to the corresponding projector. The image signal that is generated in each image reproduction unit is supplied to the seamless processing unit. The synchronizing control unit synchronizes the generation of the image frames by each image reproduction unit.

The seamless processing unit subjects the image signals that are supplied from each image reproduction unit to a correction process based on correction data that are supplied from the image processing unit. Each of the image signals that have been corrected is supplied to the corresponding projector by way of the image signal switch unit.

The test image creation unit generates a test image. The test image that is supplied as output from the test image creation unit is supplied to each projector by way of the image signal switch unit.

The image signal switch unit connects each projector with the seamless processing unit during normal operation, but connects each projector with the test image creation unit during adjustment.

During adjustment, projectors that are located in odd-numbered columns and odd-numbered rows first simultaneously project onto the rear-projection screen the test images that were supplied from the test image creation unit, and the measurement camera captures each of these projected test image all at once. The image processing unit then, based on information of each test image that is supplied from the measurement camera, generates correction data for correcting color irregularities, brightness irregularities, and image distortion relating to each test image.

Projectors that are located in odd-numbered columns, and moreover, even-numbered rows next project test images that were supplied from the test image creation unit onto the rear projection screen, and the measurement camera captures each of these projected test images all at once. The image processing unit then generates correction data for correcting color irregularities, brightness irregularities, and image distortion relating to each test image based on the information of the each test image that was supplied from the measurement camera.

The same operations are carried out for projectors that are located in even-numbered columns, and moreover, in even-numbered rows as well as for projectors that are located in even-numbered columns, and moreover, odd-numbered rows, and correction data are generated by the image processing unit.

During normal operation. the image processing unit supplies correction data of each projector that was created during adjustment to the seamless processing unit. The seamless processing unit corrects the image signals from corresponding image reproduction units based on the correction data of each projector from the image processing unit. Each projector then projects an image based on the corrected image signal. In this way, images for which color irregularities, brightness irregularities, and image distortions have been corrected are projected by each projector. Because brightness among each image has been largely matched, the perception of seams between each of the images can be prevented.

In addition, scanning projectors such as raster scanning projectors that project images onto a screen by scanning with an optical beam are being used in recent projection displays.

### PRIOR TECHNICAL DOCUMENTS

### Patent Documents

### Patent Document 1: Japanese Patent No. 3575473

### DISCLOSURE OF THE INVENTION

In the multi-projection system disclosed in Patent Document 1, the entire rear-projection screen must be captured all at once by a single measurement camera, and the distance between the rear-projection screen and the measurement camera must therefore be increased to a certain extent. The multi-projection system therefore becomes large in size and demands a large installation space.

Because the distance between the rear-projection screen and the measurement camera increases as the size of the rear-projection screen increases, the above-described problem becomes prominent.

In addition, as a property of the human sense of vision, although differences in brightness among picture elements that are far apart are difficult to perceive, differences in brightness among picture elements that are close together are easily noticed. As a result, when a plurality of images is joined to form a single image, brightness adjustment preferably matches brightness of the border portions of adjacent images.

It is therefore an object of the present invention to provide a thin multi-projection system and brightness adjustment method in which the seams between adjacent images are difficult to notice.

In order to achieve the above-described objects, the multi-projection display of the present invention is a multi-projection display that includes a plurality of projector units that project onto a display screen images based on input image signals by each scanning with an optical beam and that joins together the projected images that are projected by each projector unit to display them as one image; the multi-projection display including:
a plurality of optical sensors that are provided in each of the projector units, each of the optical sensors detecting light from a plurality of specific picture elements that display the projected image of each of the projector units on the edges of a display region; and
a main control unit that causes adjustment images for adjusting brightness to be displayed by each of the projector units to light the plurality of specific picture elements at a predetermined brightness and that establishes vertical synchronization of the display of the adjustment images of each of the projector units;
wherein each of the projector units includes an image signal correction unit that acquires by means of the optical sensor brightness values of the plurality of specific picture elements when the adjustment image is displayed, creates a brightness correction table for matching the brightness of the projected image that is projected by the projector unit with the brightness of the projected image that is projected by another projector unit based on the difference of the acquired brightness values, and then uses the brightness correction table to correct the brightness of each picture element of the image based on the input image signals.

The brightness adjustment method of the present invention is a brightness adjustment method that is carried out in a multi-projection display, wherein the multi-projection display includes a plurality of projector units that project onto a display screen images based on input image signals by each scanning with an optical beam and joins together the projected images that are projected by each projector unit to display them as one image, the brightness adjustment method including:
providing in each of the projector units an optical sensor that detects light from a plurality of specific picture elements that display a projected image of each of the projector units on edges of display regions;
causing, by a main control unit, adjustment images for adjusting brightness to be displayed by each of the projector units to light the plurality of specific picture elements at a predetermined brightness and establishing, by the main control unit, vertical synchronization of the display of the adjustment images of each of the projector units; and
acquiring, by each of the projector units, brightness values of the plurality of specific picture elements by means of the optical sensor when displaying the adjustment images, based on the differences of the acquired brightness values, creating, by each of the projector units, a brightness correction table for matching the brightness of the projected image that is projected by the projector unit with the brightness of the projected image that is projected by another projector unit, and then using, by each of the projector units, the brightness correction table to correct the brightness of each picture element of an image based on the input image signals.

### BRIEF DESCRIPTION OF THE DRAWINGS

FIG. 1 is a schematic view showing the principal parts of the multi-projection display that is the first exemplary embodiment of the present invention.

FIG. 2A is a schematic view showing the detection range of an optical sensor that is used in each projector unit of the multi-projection display that is shown in FIG. 1.

FIG. 2B is a schematic view showing the configuration of a portion of the picture elements of a fluorescent screen that is used in the multi-projection display shown in FIG. 1.

FIG. 3 is a block diagram showing the configuration of each part of the multi-projection display shown in FIG. 1.

FIG. 4 is a schematic view showing an example of the image projection unit shown in FIG. 3.

FIG. 5 is a schematic view showing an example of an adjustment image that is used in the multi-projection display shown in FIG. 1.

FIG. 6A is a schematic view showing the detection range of an optical sensor and the lighted state of specific picture elements on the screen and adjacent screens of the screen.

FIG. 6B is a schematic view showing the detection range of an optical sensor and another lighted state of specific picture elements on the screen and adjacent screens of the screen.

FIG. 6C is a schematic view showing the detection range of an optical sensor and yet another lighted state of specific picture elements on the screen and adjacent screens of the screen.

FIG. 7 is a flow chart showing an example of the procedure of creating a brightness correction table that is carried out in a projector unit.

FIG. 8 is a schematic view showing the principal parts of the multi-projection display that is the second exemplary embodiment of the present invention.

FIG. 9 is a schematic view showing the detection range of an optical sensor that is used in each projector unit of the multi-projection display shown in FIG. 8.

FIG. 10 is a schematic view showing an example of an adjustment image that is used in the multi-projection display shown in FIG. 8.

FIG. 11A is a schematic view showing the detection range of an optical sensor and the lighted state of specific picture elements on the screen and adjacent screens of the screen.

FIG. 11B is a schematic view showing the detection range of an optical sensor and another lighted state of specific picture elements on the screen and adjacent screens of the screen.

FIG. 11C is a schematic view showing the detection range of an optical sensor and yet another lighted state of specific picture elements on the screen and adjacent screens of the screen.

FIG. 11D is a schematic view showing the detection range of an optical sensor and yet another lighted state of specific picture elements on the screen and adjacent screens of the screen.

FIG. 12 is a schematic view showing the principal parts of the multi-projection display that is the third exemplary embodiment of the present invention.

FIG. 13 is a schematic view showing the detection ranges of each optical sensor that is used in each projector unit of the multi-projection display shown in FIG. 12.

FIG. 14 is a schematic view showing an example of an adjustment image that is used in the multi-projection display shown in FIG. 12.

FIG. 15A is a schematic view showing the detection range of an optical sensor and the lighted state of specific picture elements on the screen and adjacent screens of the screen.

FIG. 15B is a schematic view showing the detection range of an optical sensor and another lighted state of specific picture elements on the screen and adjacent screens of the screen.

FIG. 15C is a schematic view showing the detection range of an optical sensor of yet another lighted state of specific picture elements on the screen and adjacent screens of the screen.

FIG. 15D is a schematic view showing the detection range of an optical sensor and yet another lighted state of specific picture elements on the screen and adjacent screens of the screen.

FIG. 15E is a schematic view showing the detection range of an optical sensor and yet another lighted state of specific picture elements on the screen and adjacent screens of the screen.

FIG. 15F is a schematic view showing the detection range of an optical sensor and yet another lighted state of specific picture elements on the screen and adjacent screens of the screen.

FIG. 15G is a schematic view showing the detection range of an optical sensor and yet another lighted state of specific picture elements on the screen and adjacent screens of the screen.

FIG. 15H is a schematic view showing the detection range of an optical sensor and yet another lighted state of specific picture elements on the screen and adjacent screens of the screen.

FIG. 16 is a schematic view showing another example of an adjustment image that is used in the multi-projection display shown in FIG. 8.

FIG. 17 is a schematic view showing yet another example of an adjustment image that is used in the multi-projection display shown in FIG. 8.

FIG. 18 is a schematic view showing an example of the adjacent information acquisition unit.

### EXPLANATION OF REFERENCE NUMBERS

78 Display screen
61-76 screen
82 main control unit
83 operating section
1-16 projector units
21-36 optical sensor

### EXEMPLARY EMBODIMENT

Exemplary embodiments of the present invention are next described with reference to the accompanying drawings.

### First Exemplary Embodiment

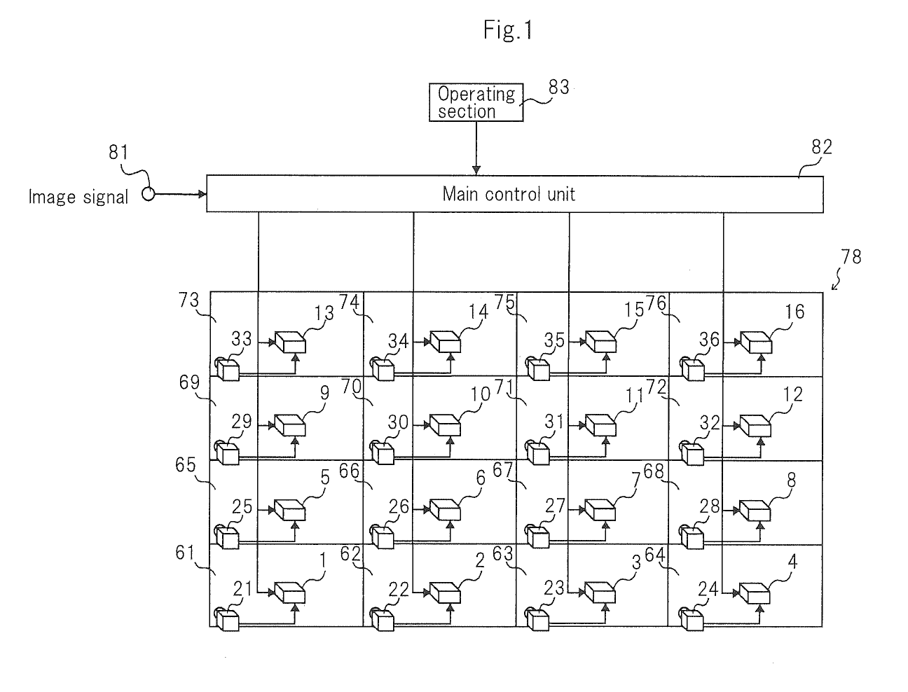

FIG. 1 is a schematic view showing the principal parts of the multi-projection display that is the first exemplary embodiment of the present invention.

As shown in FIG. 1, the multi-projection display includes: main control unit 82, operating section 83, a plurality of projector units 1-16, a plurality of optical sensors 21-36, and display screen 78.

Operating section 83 has a plurality of buttons (or operating keys) and supplies main control unit 82 with instruction signals that accord with the input operations that use these buttons. When the user carries out a specific input operation on operating section 83 for carrying out brightness adjustment, a specific instruction signal that accords with the operation of operating section 83 is supplied to main control unit 82.

Main control unit 82 starts the process for carrying out brightness adjustment based on the specific instruction signal. Main control unit 82 may otherwise carry out processing for implementing brightness adjustment at each of fixed time intervals after power is turned on.

Display creen 78 is, for example, a fluorescent screen. A fluorescent screen is a component in which a red phosphor region that contains a phosphor for which the fluorescent light color is red, a green phosphor region that contains phosphor for which the fluorescent light color is green, and a blue phosphor region that contains a phosphor for which the fluorescent light color is blue is formed cyclically in a predetermined order, a black stripe or a black matrix being formed between the phosphor regions of each color. Display screen 78 may be a screen other than a fluorescent screen.

Display screen 78 is partitioned into a plurality of screens. In the example shown in FIG. 1, display screen 78 is partitioned into 16 screens 61-76 of the same size. Display screen 78 may be made up from one screen, or may be constituted by joining together 16 screens that correspond to screens 61-76. Screens 61-76 are assumed to be in an arrangement of four columns and four rows and have a one-to-one correspondence with projector units 1-16.

Projector units 1-16 are scanning projectors (more specifically, raster scanning projectors) and project images onto display screen 78 by scanning with an optical beam. Because display screen 78 is here realized by a fluorescent screen, projector units 1-16 project images onto display screen 78 by scanning with excitation light.

Projector units 1-16 are arranged on one surface (the surface opposite the observed side) of display screen 78, and each of the projected images are displayed with a one-to-one correspondence on screens 61-76. For example, the projected image of projector unit 1 is displayed on screen 61.

The size of the projected image of projector unit 1 matches the size of screen 61. Similarly, the sizes of the projected images of the other projector units 2-16 also match the sizes of each of screens 62-76. In this way, a single image is presented on display screen 78 by joining together the projected images of projector units 1-16 without gaps.

Optical sensors 21-36 are also arranged on one surface (the surface opposite the observed surface) of display screen 78. Optical sensors 21-36 are made up of, for example, photodiodes (PD) or image pickup elements of which a CCD camera is representative and have a one-to-one correspondence with projector units 1-16. The output of optical sensor 21 is supplied to projector unit 1. The output of each of optical sensors 22-36 is supplied to the corresponding projector unit among projector units 2-16.

Optical sensor 21 is provided in the vicinity of the lower left corner of screen 61. Optical sensor 21 is able to detect both the brightness of a specific picture element in the vicinity of the lower left corner of screen 61 and the brightness of picture elements that are adjacent to the above-described specific picture element of the screens that are adjacent on the lower side and the left side of screen 61. In the arrangement shown in FIG. 1, other screens do not exist on the left side and lower side of screen 61.

Optical sensors 22-36 also have the same arranged state as optical sensor 21 and are each able to detect both the brightness of the specific picture element in the vicinity of the lower left corner of the corresponding screen among screens 62-76 and the brightness of picture elements that are adjacent to the above-described specific picture element of screens that are adjacent on the left side and lower side of the corresponding screen.

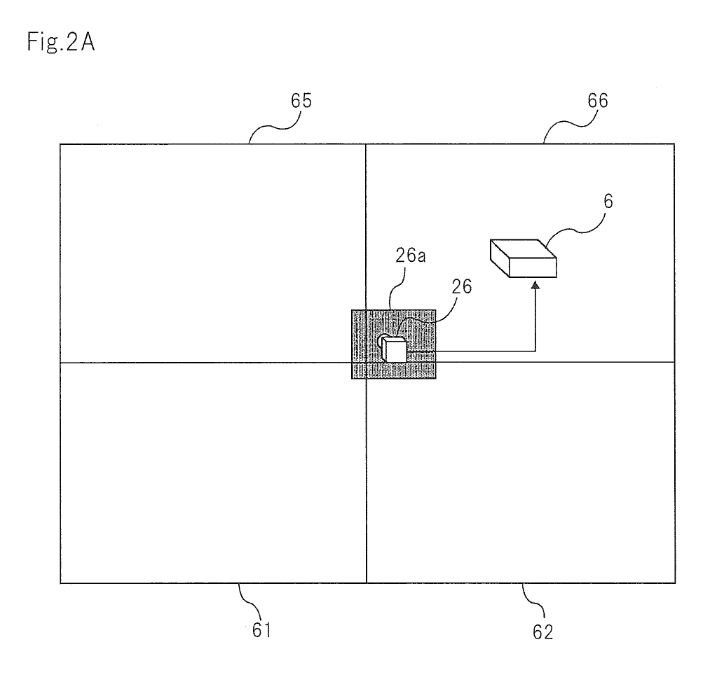

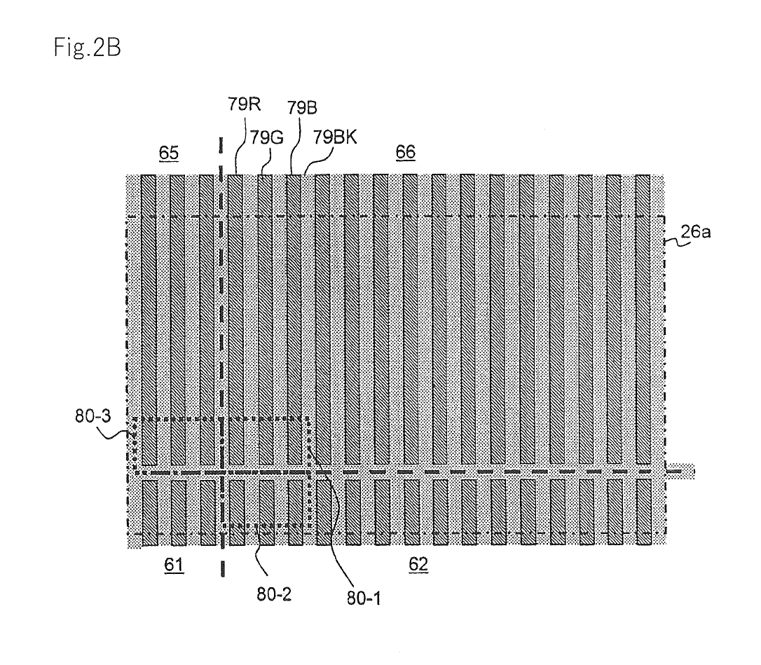

FIG. 2A gives a schematic representation of the detection range of optical sensor 26. Detection range 26a of optical sensor 26 includes the region in the vicinity of the lower left corner that is formed by the left side portion and lower side portion of screen 66 and the region that is adjacent to the vicinity of the above-described corners of screens 61,62, and 65. Optical sensors 21-25 and 27-36 also have the same detection range as optical sensor 26.

Optical sensors 21-36 are able to detect brightness of picture elements for each of the colors red, green, and blue. FIG. 2B gives a schematic representation of picture elements in detection range 26a of optical sensor 26 shown in FIG. 2A. In FIG. 2B, the long-dashed line indicates the borders of screens 61,62,65, and 66 of display screen 78. The rectangular region surrounded by the short-dashed line indicates a picture element.

Referring to FIG. 2B, screen 66 has a construction in which red phosphor stripe 79R, green phosphor stripe 79G, and blue phosphor stripe 79B are arranged cyclically in that order, black stripes BK being formed between phosphor stripes 79R, 79G, and 79B of each color.

Screen 66 has a plurality of picture elements 80-1 arranged in a matrix. Each of picture elements 80-1 includes a portion of red phosphor stripe 79R, a portion of green phosphor stripe 79G, and a portion of blue phosphor stripe 79B.

The optical beam (excitation light) from projector unit 6 is scanned in a direction that crosses each of red phosphor stripe 79R, green phosphor stripe 79G, and blue phosphor stripe 79B. For example, the excitation light is scanned in the direction from the left to the right in picture element 80-1 that is located in the lower left of screen 66.

When the excitation light irradiates red phosphor stripe 79R, red fluorescent light is emitted from picture element 80-1. When the excitation light irradiates green phosphor stripe 79G, green fluorescent light is emitted from picture element 80-1. When the excitation light irradiates blue phosphor stripe 79B, blue fluorescent light is emitted from picture element 80-1.

Screens 62 and 65 are of the same configuration. Screen 62 has a plurality of picture elements 80-2 arranged in matrix fain', and screen 65 has a plurality of picture elements 80-3 arranged in matrix form. Picture elements 80-2 and 80-3 are of the same configuration as picture elements 80-1. The other screens 61,64, and 67-76 are also of the same configuration as screen 66.

In picture elements 80-1, fluorescent light of each of the colors red, green, and blue is emitted at mutually different timings, whereby optical sensor 26 is able to individually detect the fluorescent light of each color. Similarly, fluorescent light of each of the colors red, green, and blue is emitted at mutually different timings in picture elements 80-2 and 80-3, whereby optical sensor 26 is able to separately detect the emitted fluorescent light of each color for each of picture elements 80-2 and 80-3 that are adjacent to picture elements 80-1. Optical sensor 26 has sensitivity to each of the colors of red, green, and blue, such as a color CCD camera, and may be of a construction that simultaneously supplies (detects) signals that individually respond to each color.

The other optical sensors 21-25 and 27-36 are arranged similar to optical sensor 26 and are able to detect fluorescent light of each of the colors red, green, and blue that is emitted from specific picture elements that are adjacent to each other between the corresponding screen and adjacent screens among screens 61-65 and 67-76.

Again referring to FIG. 1, image signals that are supplied from an external image reproduction device are supplied to main control unit 82 by way of image signal input unit 81.

During normal operation, main control unit 82 generates image signals to projector units 1-16 based on the image signals that are supplied from the external image reproduction device. More specifically, main control unit 82 divides images that are based on the image signals supplied from the external image reproduction device into 16 portions according to screens 61-76 and generates divided image signals that correspond to each of divided images. Main control unit 82 then supplies the divided image signals that were generated to corresponding projector units of projector units 1-16.

During brightness adjustment, main control unit 82 transmits an adjustment control signal and image signals for adjustment to projector units 1-16. The image signals for adjustment that are transmitted to projector units 1-16 are the same. During the transmission of the adjustment control signals, main control unit 82 transmits information and instruction signals that are required for creation of brightness correction tables to projector units 1-16. The necessary information and instruction signal may make up a portion of the adjustment control signals.

The actual operations of main control unit 82 and projector units 1-16 are next described.

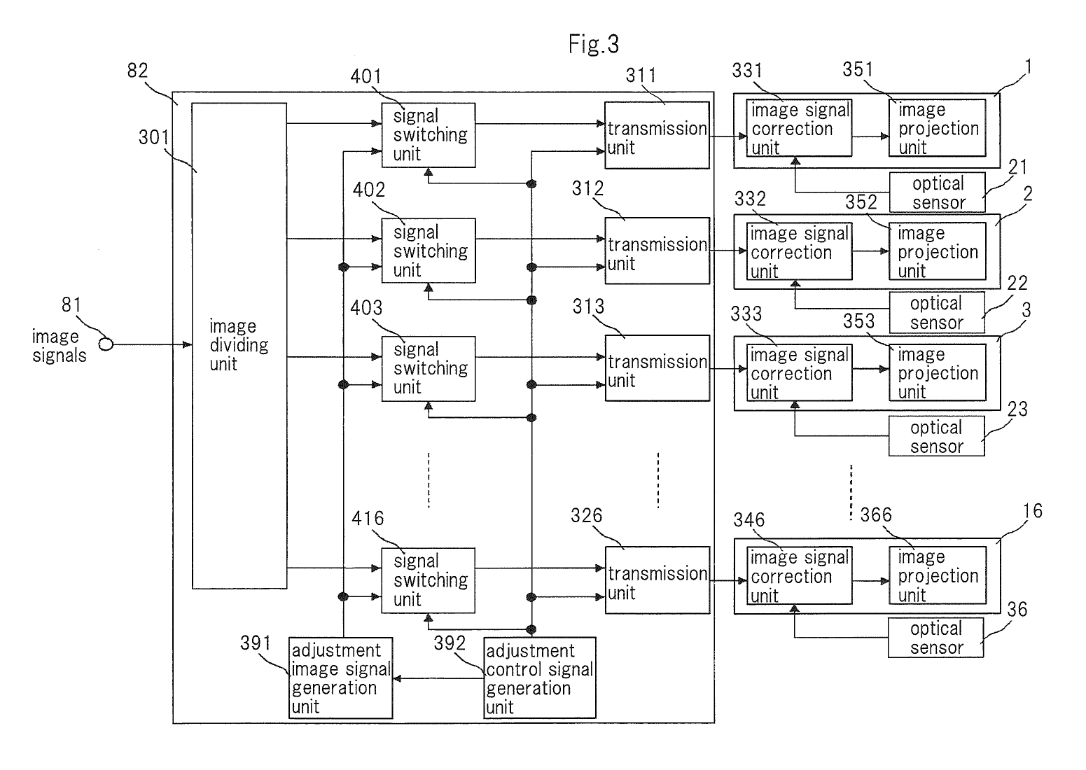

FIG. 3 is a block diagram showing the functions and connection relations of each part of the multi-projection display shown in FIG. 1.

Referring to FIG. 3, main control unit 82 includes: image dividing unit 301, signal switching units 401-416, transmission units 311-326, adjustment image signal generation unit 391, and adjustment control signal generation unit 392.

Adjustment control signal generation unit 392 supplies adjustment control signals that instruct the timing of execution of brightness adjustment. The adjustment control signals are both supplied to signal switching units 401-416 and supplied to projector units 1-16 by way of transmission units 311-326. After the output of adjustment control signals, adjustment control signal generation unit 392 causes the generation of adjustment image signals by adjustment image signal generation unit 391.

Image dividing unit 301 generates first to sixteenth divided image signals for supply to projector units 1-16 based on the image signals that are supplied from an external image reproduction device. The first to sixteenth divided image signals correspond to each of screens 61-76. Each of the first to sixteenth divided image signals is supplied to one input terminal of a corresponding signal switching unit among signal switching units 401-416.

Adjustment image signal generation unit 391 generates adjustment image signals for adjusting the brightness of images that are projected by projector units 1-16 in accordance with the instructions from adjustment control signal generation unit 392. The adjustment image signals that are supplied as output from adjustment image signal generation unit 391 are supplied to the other input terminal of signal switching units 401-416.

In signal switching units 401-416, input switching is carried out in accordance with the adjustment control signals from adjustment control signal generation unit 392. More specifically, signal switching units 401-416 supply adjustment image signals that are supplied from adjustment image signal generation unit 391 during a brightness adjustment interval that has been instructed by an adjustment control signal, and during other intervals, supply divided image signals that are supplied from image dividing unit 301.

Signal switching units 401-416 and transmission units 311-326 have a one-to-one correspondence. Each of the image signals that are supplied from signal switching units 401-416 is supplied to a corresponding transmission unit among transmission units 311-326.

Transmission units 311-326 and projector units 1-16 have a one-to-one correspondence. Each of transmission units 311-326 supplies image signals that have been supplied from corresponding signal switching unit among signal switching units 401-416 to a corresponding projector unit among projector units 1-16. In addition, transmission units 311-326 supply adjustment control signals that have been supplied from adjustment control signal generation unit 392 to a corresponding projector unit among projector units 1-16.

Projector units 1-16 are of the same configuration. The configuration and operations of projector unit 1 is here described specifically, and a detailed explanation regarding the other projector units 2-16 is omitted.

Projector unit 1 includes image signal correction unit 331 and image projection unit 351. Image projection unit 351 is of the scanning type and projects an image based on the image signals that are supplied from image signal correction unit 331 (normal images or images for adjustment) onto screen 61 of display screen 78.

During normal operation, first divided image signals that were transmitted from transmission unit 311 are supplied to image signal correction unit 331, and during brightness adjustment, adjustment control signals and adjustment image signals that are transmitted from transmission unit 311 are supplied to image signal correction unit 331.

Image signal correction unit 331 recognizes a brightness adjustment interval based on an adjustment control signal. During a brightness adjustment interval, image signal correction unit 331 supplies adjustment image signals and a synchronizing signal (a signal for establishing vertical synchronization of a projected image) that is included in adjustment control signals to image projection unit 351.

Image projection unit 351 projects an image based on the adjustment image signals onto screen 61 in accordance with the synchronizing signal (vertical synchronizing signal), and image signal correction unit 331 creates a brightness correction table based on the output signal of optical sensor 21. The brightness correction table is created for each of the colors red, green, and blue.

The synchronizing signal is supplied to projector units 1-16 at the same timing. As a result, the timing of the start of projection of adjustment images based on the adjustment image signals realized by image projection unit 351 of projector unit 1 matches the timing of the start of projection of adjustment images based on the adjustment image signals realized by other projector units 2-16. In other words, vertical synchronization is established for adjustment images that are projected by projector units 1-16.

Image signal correction unit 331 saves in advance characteristic data that indicate the relation of the input values and output values for each of the colors red, green, and blue as the initial state. Image signal correction unit 331 then, based on the output signal of optical sensor 21 for each color, acquires the differences between the brightness of fluorescent light that is emitted from the specific picture element of the outermost portion of the adjustment image that is projected from projector unit 1 and the brightness of fluorescent light that is emitted from the picture elements adjacent to the above-described specific picture element of the adjustment image that is projected from adjacent projector units, and based on these differences, amends the characteristic data of corresponding colors that have been saved in advance and creates a brightness correction table based on the amended characteristic data.

The relationship between the intensity of excitation light and the brightness of fluorescent light is typically a linear relationship. For example, image signal correction unit 331 saves characteristic data that indicate the relationship between each item of data of gray-level ranges (for example, 256 gray levels) and brightness values, and is able to obtain the above-described amended characteristic data by shifting the characteristic data based on the difference between the brightness value of the specific picture element of its own screen and the brightness value of the specific picture element of an adjacent screen.

Image signal correction unit 331 further partitions the gray-level ranges at a plurality of points for each fixed gray-level range, saves characteristic data that indicate the relation with the brightness value for each point, and, based on the difference between the brightness value of the specific picture element of its own screen and the brightness value of the specific picture element of an adjacent screen, is able to both correct the brightness value that corresponds to each point and obtain the above-described amended characteristic data by finding through calculation data between each point after correction.

The operations of image signal correction unit 331 and image projection unit 351 of projector unit 1 are next described more specifically.

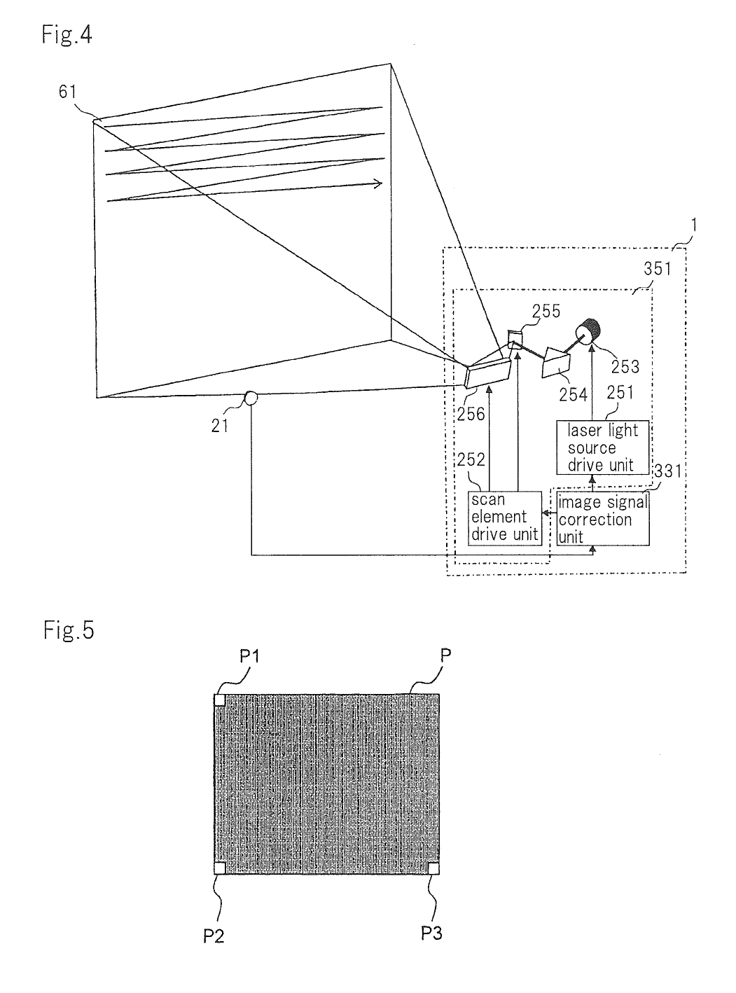

FIG. 4 shows an example of the image projection unit shown in FIG. 3. Referring to FIG. 4, image projection unit 351 includes: laser light source drive unit 251, scan element drive unit 252, laser light source 253, optics 254, horizontal scan element 255, and vertical scan element 256.

Laser light source 253 supplies laser light (excitation light) for excitation of the phosphor that is contained in the phosphor stripes of each color (red phosphor stripe 79R, green phosphor stripe 79G, and blue phosphor stripe 79B as shown in FIG. 2B) that are formed on screen 61 of display screen 78.

Optics 254 are provided in the direction of advance of laser light that is supplied from laser light source 253 and reflect incident laser light toward horizontal scan element 255. Horizontal scan element 255 is composed of a resonant scan mirror of which, for example, an MEMS (Micro Electro Mechanical Systems) mirror is representative and implements back-and-forth scanning in the horizontal direction with laser light from optics 254.

Vertical scan element 256 is provided in the direction of advance of laser light from horizontal scan element 255 and implements up-and-down scanning in the vertical direction with laser light from horizontal scan element 255. Vertical scan element 256 may be composed of a scanning means such as a polygon mirror or galvano-mirror.

Laser light source drive unit 251 drives laser light source 253 in accordance with the brightness values of each picture element of an image that is based on image signals that are supplied from image signal correction unit 331. Scan element drive unit 252 drives horizontal scan element 255 and vertical scan element 256 in accordance with synchronizing signals (horizontal synchronizing signal and vertical synchronizing signal) of the image signals that are supplied from image signal correction unit 331.

During a brightness adjacent interval that has been instructed by an adjustment control signal from main control unit 82, image signal correction unit 331 both supplies adjustment image signals for each color from main control unit 82 to image projection unit 351 and creates brightness correction tables for each color based on the detection results of each color from optical sensor 21.

At the time of normal operation other than brightness adjustment intervals, image signal correction unit 331 applies brightness correction based on the brightness correction tables for each color to the first divided image signals of each color from main control unit 82 and supplies the first divided image signals of each color that have undergone brightness correction to image projection unit 351.

More specifically, first divided image signals include divided image signals for red, divided image signals for green, and divided image signals for blue. The divided image signals for each color are each composed of a plurality of items of picture element data that are arranged in time series. Image signal correction unit 331 applies brightness correction based on the brightness correction tables of each color for the divided image signals of each color. In image projection unit 351, laser light source drive unit 251 and scan element drive unit 252 operate in accordance with the divided image signals that have undergone brightness correction for each color, and red images, green images, and blue images are projected onto screen 61 in time divisions.

Projector units 2-16 also include image signal correction units and image projection units similar to image signal correction unit 331 and image projection unit 351 of projector unit 1.

The method of creating the brightness correction tables for each color is next described more specifically.

The brightness correction tables of each color are all created by the same procedure. The method of creating the brightness correction table for red is here described and description regarding the other colors is omitted.

FIG. 5 shows an example of a projected image (red adjustment image) based on an adjustment image signal. Projected image P is made up from a plurality of picture elements that are arranged in matrix form, fluorescent light (red) having a fixed brightness being emitted at picture element P1 that is located on the upper left when facing the screen, picture element P2 that is located on the lower left, and picture element P3 that is located on the lower right, and fluorescent light not being emitted from picture elements other than these picture elements P1-P3. Picture elements P1-P3 are specific picture elements that are used when acquiring brightness differences with adjacent screens.

Adjustment image signals of projected image P shown in FIG. 5 are supplied to projector units 1-16. Projector units 1-16 project projected images P onto screens 61-76 based on the adjustment image signals.

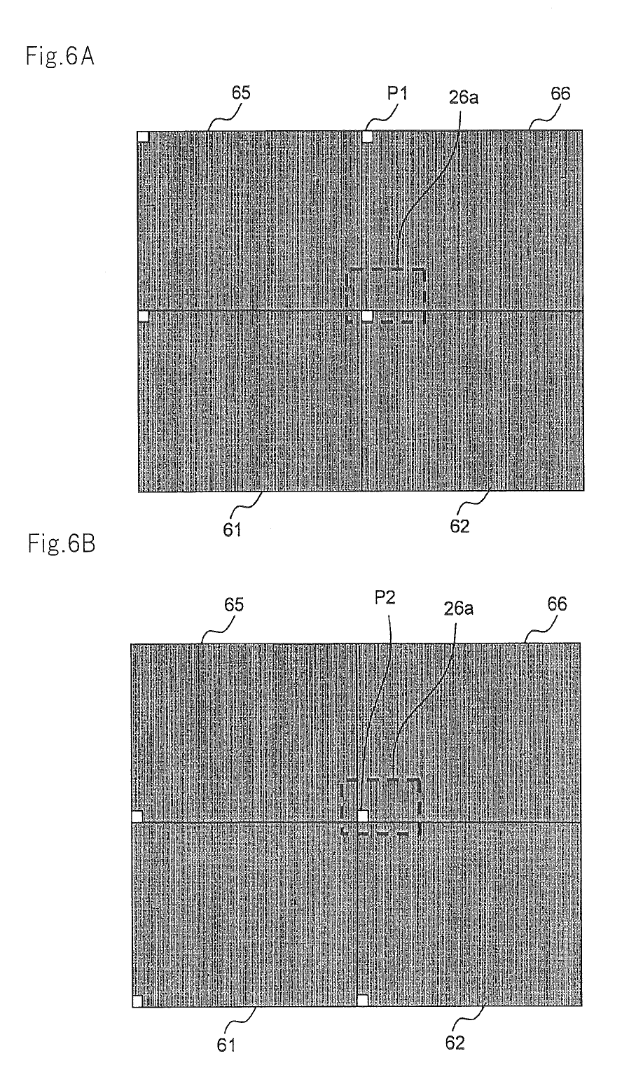

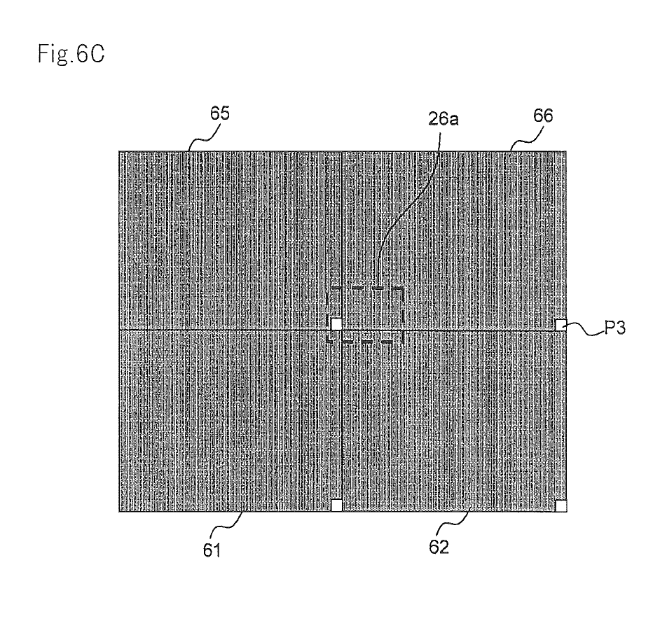

FIGS. 6A-6C give a schematic representation of the procedure of acquiring differences in brightness of specific picture elements between the screen and adjacent screens when creating the brightness correction table for red. The procedures shown in FIGS. 6A-6C are the procedures executed by projector unit 6 when main control unit 82 supplies adjustment image signals of projected image P shown in FIG. 5 to projector units 1, 2, 5, and 6.

When scanning of the excitation light begins, picture elements P1 in screens 61, 62, 65, and 66 are first lighted as shown in FIG. 6A. In this case, of picture elements P1 of the lighted state of screens 61, 62, 65, and 66, only picture element P1 of screen 62 is located within detection range 26a of optical sensor 26 that corresponds to projector unit 6. Optical sensor 26 accordingly detects only red fluorescent light from picture element P1 of screen 62 that is adjacent to the lower side of screen 66 and supplies the result (first detection result) to projector unit 6.

After picture element P1 is irradiated, excitation light is not irradiated from the picture element immediately after picture element P1 to the picture element immediately before picture element P2.

The state in which excitation light irradiates picture elements P2 is the state shown in FIG. 6B. In this state, picture elements P2 on screens 61, 62, 65, and 66 are lighted, and of picture elements P2 of this lighted state, only picture element P2 of screen 66 is located within detection range 26a of optical sensor 26. Optical sensor 26 accordingly detects only the red fluorescent light from picture element P2 of screen 66 and supplies the result (second detection result) to projector unit 6.

After picture element P2 is irradiated, excitation light is not irradiated from the picture element immediately after picture element P2 to the picture element immediately before picture element P3.

The state in which excitation light irradiates picture elements P3 is the state shown in FIG. 6C. In this state, picture elements P3 are lighted in screens 61, 62, 65, and 66, and of picture elements P3 in this lighted state, only picture element P3 of screen 65 is located within detection range 26a of optical sensor 26. Optical sensor 26 accordingly detects only the red fluorescent light from picture element P3 of screen 65 and supplies this result (third detection result) to projector unit 6.

In projector unit 6, the first to third detection results in each of the states shown in FIGS. 6A-6C are supplied from optical sensor 26 to image signal correction unit 336. Image signal correction unit 336 selects one result from among the first and third detection results by a predetermined procedure and creates a brightness correction table for red based on the difference between the detection result that was selected and the second detection result.

Because projector units 1-16 are of the scanning type shown in FIG. 4, the timings of lighting picture elements P1-P3 of projected image P (the timings of fluorescent light emission) are each different. In other words, picture elements P1-P3 light one at a time in sequence at different timings along the scanning direction in projected image P.

In projector units 1-16, the projected images P are displayed according to synchronizing signals (vertical synchronizing signals) from main control unit 82. Accordingly, mutual vertical synchronization is established among each of projected images P that are projected by projector units 1-16 and the timing of lighting of picture elements P1 therefore matches.

On the other hand, horizontal synchronization is not established among each of projected images P, and shifting therefore occurs successively with the progress of scanning for picture elements other than picture elements P1. As a result, a shift in the timing of lighting of picture elements P2 and P3 occurs between each projected image P, but this shift is slight.

Projected images P light only picture elements P1-P3 and do not light other picture elements. Accordingly, in each projected image P, image signal correction unit 336 is able to acquire each of the brightness values of picture element P1 of screen 62, the brightness value of picture element P2 of screen 66, and the brightness value of picture element P3 of screen 65 based on the output signals of the optical sensor and the adjustment image signals of projected images P that are supplied from main control unit 82.

Brightness correction tables for green and blue are created by a procedure similar to that described above.

In projector units 1-5 and 7-16 as well, brightness correction tables for red, green, and blue can be created by procedures similar to projector unit 6.

The method of creating brightness correction tables was explained hereinabove taking projector unit 6 as an example. However, in the arrangement shown in FIG. 1, another screen does not exist on the lower side in each of screens 61-64, and further, another screen does not exist on the left side in each of screens 61,65,69, and 73. As a result, the creation of the brightness correction tables in projector units 1-16 must be carried out in the appropriate order depending on the absence or existence of adjacent projector units.

The method of creating brightness correction tables in projector units 1-16 is next described specifically including the order of creating brightness correction tables.

Main control unit 82 holds information indicating the arrangement shown in FIG. 1 (unit connection information indicating the connection relations among projector units 1-16), and at the time of brightness adjustment, transmits to each of projector units 1-16 unit connection information and an instruction signal (brightness correction table creation instruction signal) instructing the creation of brightness correction tables in the appropriate order. The unit connection information and brightness correction table creation instruction signal may make up a portion of an adjustment control signal.

The unit connection information is table information in which are stored, for each item of identification information of projector units 1-16, identification information of the projector unit that is adjacent on the left side and identification information of the projector unit that is adjacent on the lower side. Each of projector units 1-16 holds its own identification information, and by referring to the column of its own identification information within the table information, judges whether there are projector units adjacent on the left side and lower side and selects first and third detection results based on the judged result.

When projector units are adjacent on both the left side and lower side, each of projector units 1-16 creates a brightness correction table giving priority to one of these adjacent projector units. It will be here assumed that the adjacent projector unit on the left side is given priority.

The procedures of creating brightness correction tables based on the brightness correction table creation instruction signal and unit connection information that are carried out in image signal correction units 331-346 of projector units 1-16 are next described.

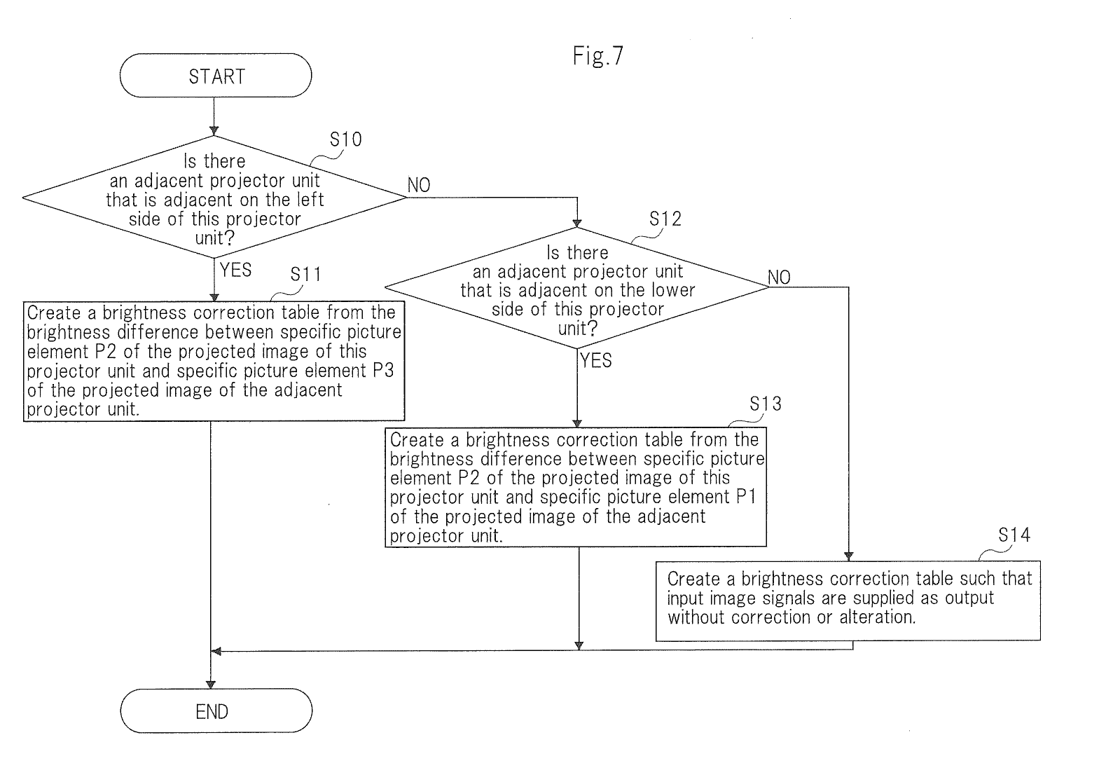

FIG. 7 shows an example of this creation procedure. Since the creation procedures of image signal correction units 331-346 are the same, only the operation of an individual image signal correction unit is explained below.

Upon receiving the brightness correction table creation instruction signal and unit connection information from main control unit 82, the image signal correction unit judges based on the unit connection information whether there is an adjacent projector unit that is adjacent on the left side of its own projector unit (Step S10).

If an adjacent projector unit is judged to exist in Step S10, the image signal correction unit next creates a brightness correction table based on the difference between the brightness value of picture element P2 (second detection result supplied from the optical sensor) of projected image P (see FIG. 5) of the projector unit and the brightness value of picture element P3 (third detection result supplied from the optical sensor) of projected image P of the adjacent projector unit (Step S11). The image signal correction unit then transmits a completion notification to main control unit 82.

If an adjacent projector unit that is adjacent is judged not to exist in Step S10, the image signal correction unit next judges based on the unit connection information whether there is an adjacent projector unit that is adjacent on the lower side of its own unit (Step S12).

If an adjacent projector unit is judged to exist in Step S12, the image signal correction unit creates a brightness correction table based on the difference between the brightness value of picture element P2 of projected image P of the projector unit and the brightness value of picture element P3 (third detection result supplied from the optical sensor) of projected image P of the adjacent projector unit (Step S13). The image signal correction unit then transmits a completion notification to main control unit 82.

If an adjacent projector unit is judged not to exist in Step S12, the image signal correction unit creates a brightness correction table such that the input image signals are supplied as unaltered output without being corrected (Step S14). The image signal correction unit then transmits a completion notification to main control unit 82.

According to the processing of the above-described Steps S10-S14, brightness correction tables are created for each of red, green, and blue in projector unit 1 such that input image signals are supplied as output without correction. In each of projector units 5, 9, and 13, brightness correction tables are created for each of the colors red, green, and blue based on the differences between the brightness values of picture element P2 of projected image P of the projector unit and the brightness value of picture element P1 of projected image P of the adjacent projector unit on the lower side. In each of projector units 2-4, 6-8, 10-12, and 14-16, brightness correction tables are created for each of the colors of red, green, and blue based on the differences between the brightness values of picture element P2 of projected image P of the projector unit and the brightness values of picture element P3 of projected image P of the adjacent projector unit.

Projector units 1-16 simultaneously carry out the processes of creating brightness correction tables to adjust brightness by the procedures shown in FIG. 7. If these adjustment processes are repeated several times, the brightness of the projected images of each color of projector units 2-16 can be adjusted with the projected image of each color of projector unit 1 as a standard to obtain projected images of uniform brightness for entire display screen 78. Main control unit 82 causes projector units 1-16 to carry out the adjustment process a predetermined number of times.

At the time of adjusting brightness, projector units 1-16 project adjustment images such as shown in FIG. 5 a plurality of times. This step of projecting adjustment images a plurality of times may be carried out continuously in one brightness adjustment interval, or first to seventh brightness adjustment intervals may be set and one projection step may be carried out during each brightness adjustment interval. In the latter case, a step of normal operation in which images are projected based on divided image signals may be carried out between each brightness adjustment interval. For example, the above-described step of projecting a plurality of times may be carried out in a procedure in which one adjustment image projection step is carried out each time images based on divided image signals of one frame or a plurality of frames are projected.

After the creation of brightness correction tables has been completed by projector units 1-16 as described hereinabove, main control unit switches the operating mode to the normal operation mode.

During normal operation, image signal correction units 331-346 in projector units 1-16 subject the divided image signals of each color that are applied as input to brightness correction based on the brightness correction data of each color. Image projection units 351-366 then project the images that are based on the divided image signals of each color that follow brightness correction onto screens 61-76.

According to the multi-projection display of the present exemplary embodiment as described hereinabove, the detection range of optical sensors is a range in the vicinity of the lower left of projected images (screens), whereby the distance between an optical sensor and the screen can be sufficiently decreased compared to a case in which an entire screen is detected by a single optical sensor. The shorter distance between the optical sensor and screen enables the realization of a more compact multi-projection system.

In addition, as described hereinabove, due to the characteristics of human vision, differences in brightness between picture elements that are located far apart are difficult to perceive, but differences in brightness between adjacent picture elements are easily noticeable. In the present exemplary embodiment, this characteristic of the sense of vision is taken into consideration and differences in brightness between picture elements that are adjacent at the border portions of screens are reduced, whereby the effect is obtained in which seams between each screen are difficult to perceive.

In the multi-projection display of the present exemplary embodiment, configuration and operation can be modified as appropriate. For example, optical sensors 21-36 were arranged in the vicinities of the lower left corners of the four corners of corresponding screens of screens 61-76, but optical sensors 21-36 may also be arranged in any of the upper left corners, the lower right corners, or the upper right corners.

When the optical sensors are arranged in the upper left corners, the projector units acquire brightness differences of specific picture elements with respect to adjacent projector units on the left side and upper side and create brightness correction tables for each color based on the acquired brightness differences. In this case, picture elements P1-P3 shown in FIG. 5 are each picture elements located in each of the lower left, upper left, and upper right corner portions of a screen.

When optical sensors are arranged in the lower right corners, the projector units acquire differences in brightness of specific picture elements with adjacent projector units on the right side and lower side and create brightness correction tables for each color based on the acquired differences in brightness. In this case, picture elements P1-P3 shown in FIG. 5 are taken as picture elements located in the lower left corner, lower right corner, and upper right corner, respectively, of the screens.

When the optical sensors are arranged in the upper right corners, the projector units acquire differences in brightness of specific picture elements with adjacent projector units on the right side and upper side and create brightness correction tables for each color based on the acquired differences in brightness. In this case, picture elements P1-P3 shown in FIG. 5 are taken as picture elements located in the upper left corner, upper right corner, and lower right corner, respectively, of the screens.

The adjustment image is not limited to the image shown in FIG. 5. Any kind of adjustment image can be used as long as the difference in brightness of picture elements that are adjacent across the screen border portion between the projector unit and an adjacent projector unit can be acquired.

For example, the number of specific picture elements may be three or more. More specifically, a plurality of each of first sets of picture elements P2 and picture elements P1 and second sets of picture elements P2 and picture elements P3 are provided in the adjustment image shown in FIG. 5. If an adjacent projector unit is present on the lower side of the projector unit in this case, the differences in brightness between picture elements P1 and P2 are found for each first set, and brightness correction tables are then created based on the average values of these differences in brightness. If an adjacent projector unit is present on the left side of the projector unit, the differences in brightness are found between picture elements P2 and P3 for each second set and brightness correction tables are created based on the average values of these differences in brightness. In this way, differences in brightness between picture elements that are adjacent in the screen border portions between a screen of the projector unit and an adjacent screen can be reduced, thereby making seams more difficult to perceive.

### Second Exemplary Embodiment

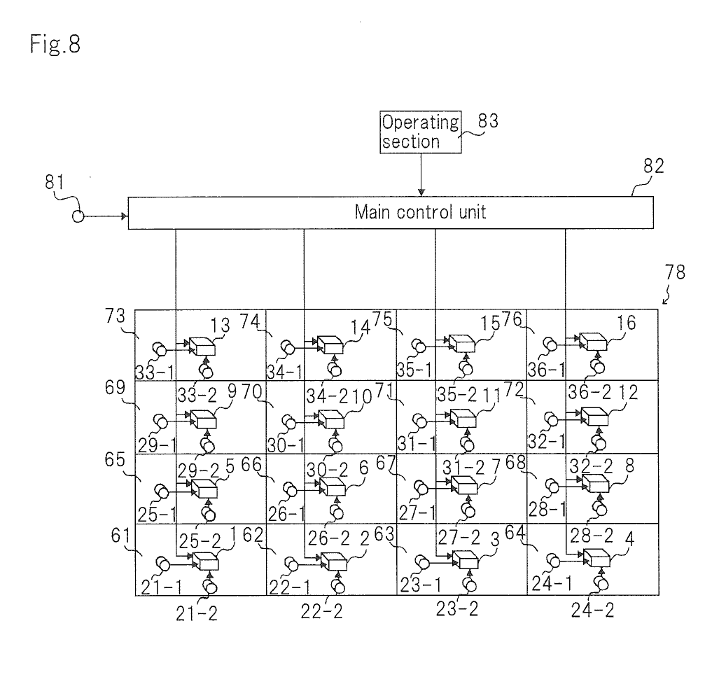

FIG. 8 is a schematic view showing the principal parts of a multi-projection display that is the second exemplary embodiment of the present invention.

The multi-projection display of the present exemplary embodiment differs from the multi-projection display of the first exemplary embodiment in that two optical sensors are provided for one projector unit.

First optical sensors 21-1-36-1 have a one-to-one correspondence with projector units 1-16, and second optical sensors 21-2-36-2 also have a one-to-one correspondence with projector units 1-16.

Projector unit 1 creates a brightness correction table for each color based on each output signal of first optical sensor 21-1 and second optical sensor 21-2. Each of projector units 2-16 similarly creates brightness correction tables for each color based on each output signal of the corresponding first optical sensor among first optical sensors 22-1-36-1 and the corresponding second optical sensor among second optical sensors 22-2-36-2.

The procedure of creating brightness correction tables in projector units 1-16 is basically the same as that of the first exemplary embodiment, but in the present exemplary embodiment, first and second optical sensors are used to detect the differences in brightness of specific picture elements with adjacent projector units on the left side and lower side. As a result, the detection ranges of first and second optical sensors and the adjustment image signals that are used at the time of brightness adjustment differ from the first exemplary embodiment.

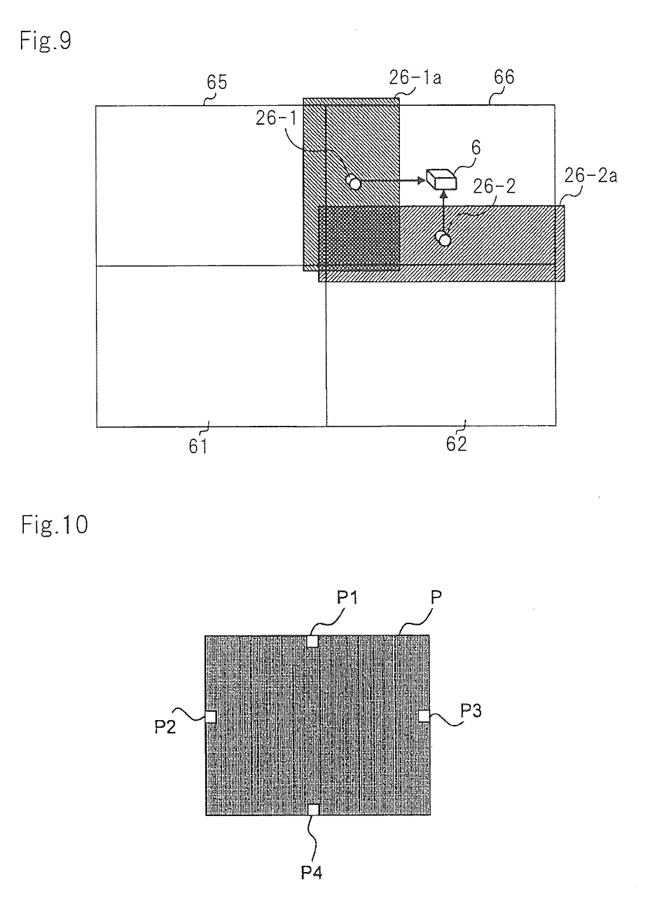

FIG. 9 gives a schematic representation of each of the detection ranges of first optical sensor 26-1 and second optical sensor 26-2 for the projection screen realized by projector unit 6.

First optical sensor 26-1 is arranged in the vicinity of the center of the left side of screen 66, and the detection range 26-1a of this optical sensor 26-1 includes the region in the vicinity of the left side of screen 66 and the region of screen 65 that is adjacent to the left side of screen 66.

Second optical sensor 26-2 is arranged in the vicinity of the center of the lower side of screen 66 and detection range 26-2a of this optical sensor 26-2 includes the region in the vicinity of the lower side of screen 66 and a region of screen 62 that is adjacent to the left side of screen 66.

FIG. 10 shows an example of a projected image (red) based on an adjustment image signal. Projected image P is made up of a plurality of picture elements that are arranged in matrix form and includes: picture element P1 that is located in approximately the center of the upper side of the outermost periphery when facing the screen, picture element P2 that is located in approximately the center of the left side of the outermost periphery, picture element P3 that is located in approximately the center of the right side of the outermost periphery, and picture element P4 that is located in approximately the center of the lower side of the outermost periphery. Fluorescent light (red) having a fixed brightness is emitted at each of picture elements P1-P4, and fluorescent light is not emitted from picture elements other than these picture elements P1-P4. Picture elements P1-P4 correspond to the specific picture elements when acquiring differences in brightness with adjacent screens.

The adjustment image signal of projected image P shown in FIG. 10 is supplied to projector units 1-16. Projector units 1-16 project projected image P based on the adjustment image signal upon screens 61-76.

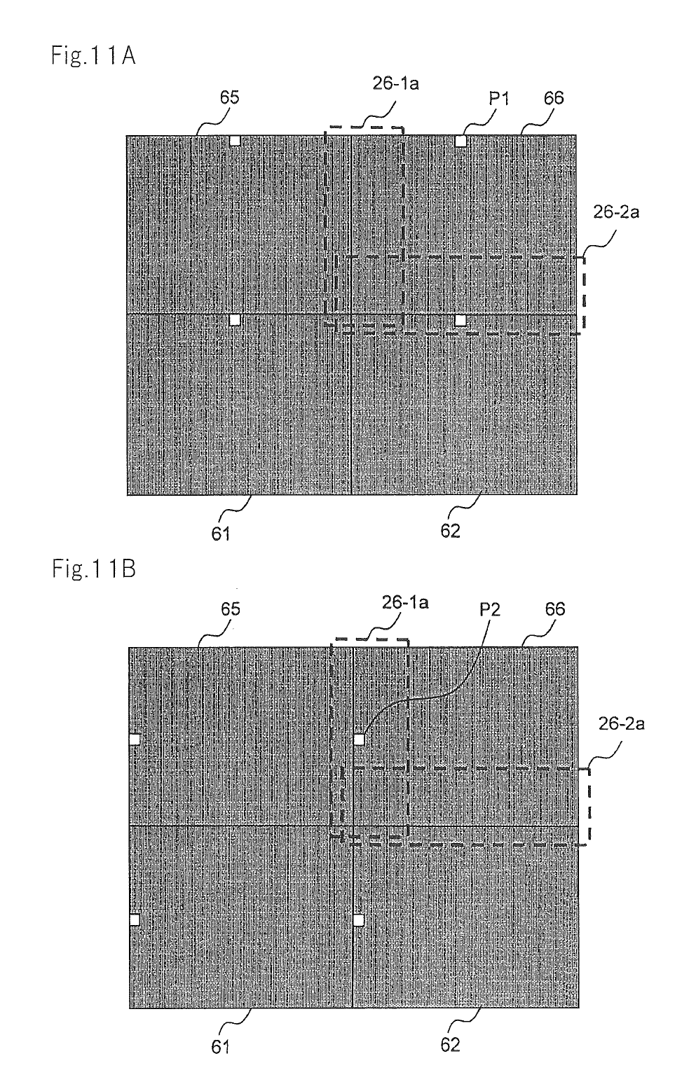

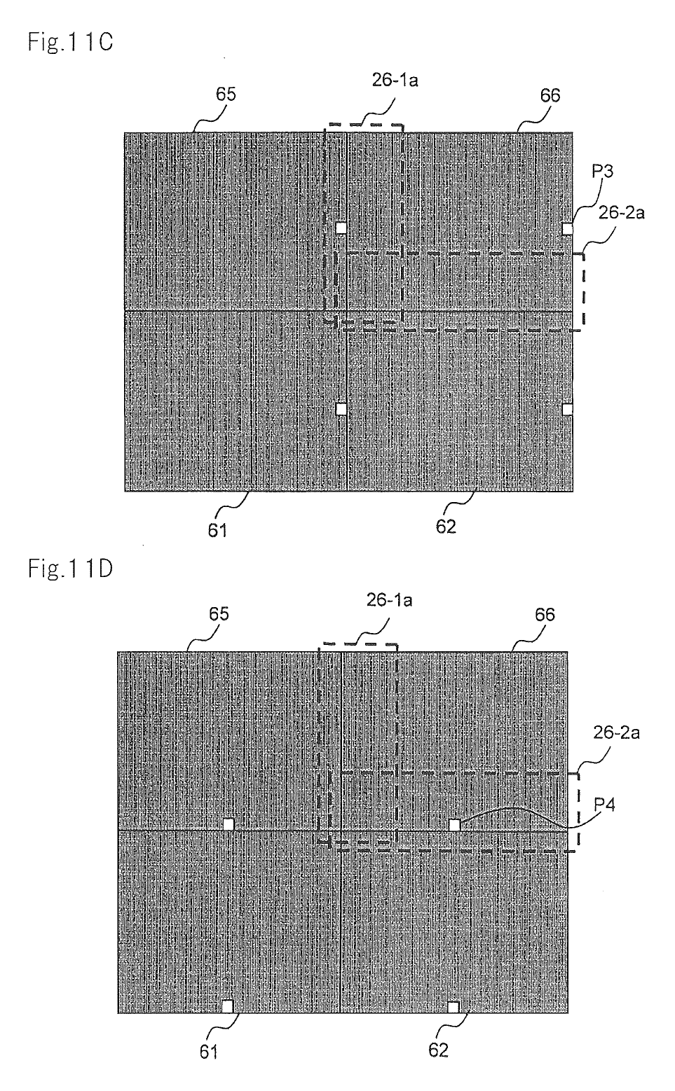

FIGS. 11A-11D give a schematic representation of the procedure of acquiring differences in brightness of specific picture elements between a screen of the projector unit and adjacent screens when creating a brightness correction table for red. The procedures shown in FIGS. 11A-11D are procedures executed by projector unit 6 when main control unit 82 supplies adjustment image signals of projected image P shown in FIG. 10 to projector units 1, 2, 5, and 6.

When scanning of the excitation light begins, picture elements P1 in screens 61, 62, 65 and 66 are first lighted as shown in FIG. 11A. In this case, of picture elements P1 in a lighted state of screens 61, 62, 65, and 66, only picture element P1 in screen 62 is located within detection range 26-2a of second optical sensor 26-2 that corresponds to projector unit 6. Second optical sensor 26-2 accordingly detects only the red fluorescent light from picture element P1 of screen 62 that is adjacent to the lower side of screen 66 and supplies this result (first detection result) to projector unit 6.

After picture element P1 is irradiated, the excitation light is not irradiated from the picture element immediately after picture element P1 to the picture element immediately before picture element P2.

FIG. 11B shows the state in which excitation light irradiates picture elements P2. In this state, picture elements P2 light up in screens 61, 62, 65, and 66, and of these lighted picture elements P2, only picture element P2 in screen 66 is located within detection range 26-1 a of first optical sensor 26-1. First optical sensor 26-1 accordingly detects only red fluorescent light from picture element P2 of screen 66 and supplies this result (second detection result) to projector unit 6.

After picture element P2 is irradiated, excitation light is not irradiated from the picture element immediately after picture element P2 to the picture element immediately before picture element P3.

FIG. 11C shows the state in which excitation light is irradiated upon picture elements P3. In this state, picture elements P3 are lighted in screens 61, 62, 65, and 66, and of these picture elements P3 that are in a lighted state, only picture element P3 of screen 65 is located within detection range 26-1a of first optical sensor 26-1. First optical sensor 26-1 accordingly detects only red fluorescent light from picture element P3 of screen 65 and supplies this result (third detection result) to projector unit 6.

After picture element P3 is irradiated, excitation light is not irradiated from the picture element immediately after picture element P3 to the picture element immediately before picture element P4.

FIG. 11D shows the state in which excitation light irradiates picture elements P4. In this state, picture elements P4 are lighted in screens 61, 62, 65, and 66, and of these picture elements P4 that are in a lighted state, only picture element P4 of screen 66 is located within detection range 26-2a of second optical sensor 26-2. Second optical sensor 26-2 accordingly detects only red fluorescent light from picture element P4 of screen 66 and reports this result (fourth detection result) to projector unit 6.

In projector unit 6, second and third detection results are supplied from first optical sensor 26-1 to image signal correction unit 336 to detect the brightness of specific picture elements between screen 65 and screen 66, and first and fourth detection results are supplied from second optical sensor 26-2 to image signal correction unit 336 to detect the brightness of specific picture elements between screen 62 and screen 66.

Image signal correction unit 336, in accordance with a predetermined procedure, selects the detection results (second and third detection results) of first optical sensor 26-1 or the detection results (first and fourth detection results) of second optical sensor 26-2 and creates a brightness correction table for red based on the selected detection results.

The procedure of creating a brightness correction table in accordance with a predetermined procedure is basically the same as the procedure shown in FIG. 7 but a portion of the processes of Steps S11 and S13 differs from the case of the first exemplary embodiment.

In the present exemplary embodiment, image signal correction unit 336 in Step S11 creates a brightness correction table based on the difference between the brightness value (second detection result supplied from first optical sensor 26-1) of picture element P2 of projected image P of projector unit 6 and the brightness value (third detection result supplied from first optical sensor 26-1) of picture element P3 of projected image P of adjacent projector unit 5.

In Step S13, image signal correction unit 336 creates a brightness correction table based on the difference between the brightness value (fourth detection result supplied from second optical sensor 26-2) of picture element P4 of projected image P of projector unit 6 and the brightness value (first detection result supplied from second optical sensor 26-2) of picture element P1 of projected image P of adjacent projector unit 2.

Brightness correction tables for green and blue can also be created by procedures that are the same as those described above.

In projector units 1-5 and 7-16 as well, brightness correction tables for each of the colors red, green, and blue can be created by procedures similar to those of projector unit 6.

Projector units 1-16 carry out the adjustment processes simultaneously, and if these adjustment processes are carried out several times, the brightness of the projected images of each color of projector units 1-16 can be approximately matched and projected images of uniform brightness can be obtained over entire display screen 78. Main control unit 82 causes projector units 1-16 to carry out the adjustment processes a predetermined number of times.

The multi-projection display of the present exemplary embodiment also exhibits the same effects as the first exemplary embodiment.

In the multi-projection display of the present exemplary embodiment, the configuration and operations can be modified as appropriate. For example, the first and second optical sensors may be provided on the two sides that are adjacent to the outermost periphery of a screen. However, the positions of the first and second optical sensors with respect to the screen must be made the same among projector units 1-16.

In addition, the adjustment image is not limited to the image shown in FIG. 10. Any type of adjustment image may be used and the number of specific picture elements may be four or more as long as differences in brightness of picture elements that are adjacent across screen boundaries among the projector unit and adjacent projector units can be acquired.

For example, in the adjustment image shown in FIG. 10, a plurality of each of first sets of picture elements P1 and picture elements P4 and second sets of picture elements P2 and picture elements P3 are provided. In this case, when an adjacent projector unit is present on the lower side of the projector unit, the differences in brightness are found between picture elements P1 and P4 for each first set and a brightness correction table is created based on the average value of these differences in brightness. When an adjacent projector unit is present on the left side of the projector unit, differences in brightness are found between picture elements P2 and P3 for each second set and a brightness correction table is created based on the average value of these differences in brightness. In this way, differences in brightness between picture elements that are adjacent to the screen boundaries between a screen of the projector unit and an adjacent screen can be reduced, whereby seams become more difficult to perceive.

### Third Exemplary Embodiment

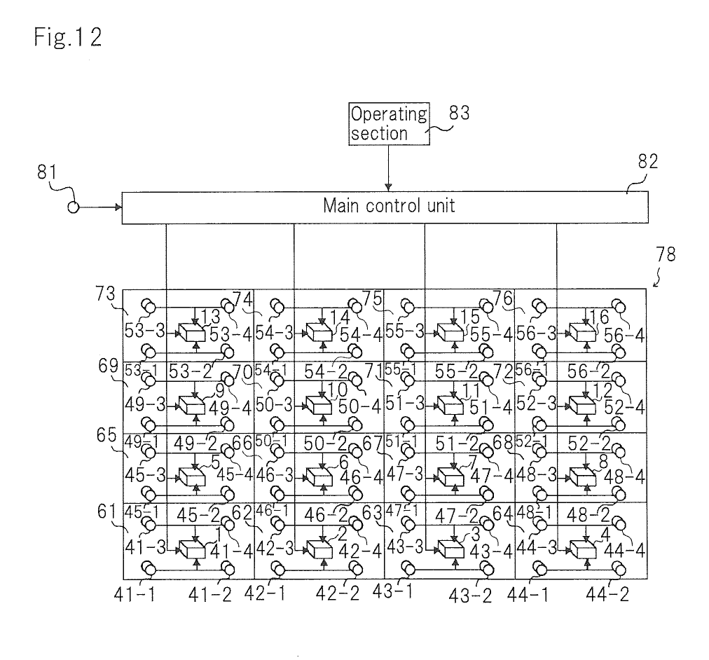

FIG. 12 is a schematic view showing the principal parts of the multi-projection display that is the third exemplary embodiment of the present invention.

The multi-projection display of the present exemplary embodiment differs from the multi-projection displays of the first and second exemplary embodiments in that four optical sensors are provided for one projector unit.

First optical sensors 41-1-56-1, second optical sensors 41-2-56-2, third optical sensors 41-3-56-3, and fourth optical sensors 41-4-56-4 each have a one-to-one relation with projector units 1-16, respectively.

Projector unit 1 creates brightness correction tables for each color based on each of the output signals of first optical sensor 41-1, second optical sensor 41-2, third optical sensor 41-3, and fourth optical sensor 41-4. Similarly, projector units 2-16 each create brightness correction tables for each color based on each of output signals of the corresponding first optical sensor among first optical sensors 42-1-56-1, second optical sensors 41-2-56-2, the corresponding third optical sensor among third optical sensors 42-3-56-3, and the corresponding fourth optical sensor among fourth optical sensors 41-4-56-4.

The procedures for creating brightness correction tables in projector units 1-16 are basically the same as those of the first exemplary embodiment, but in the present exemplary embodiment, the first to fourth optical sensors are used to detect the differences in brightness of specific picture elements with adjacent projector units on each of the upper, lower, right, and left sides. As a result, the detection ranges of the first to fourth optical sensors and the adjustment image signals that are used at the time of brightness adjustment differ from the first exemplary embodiment.

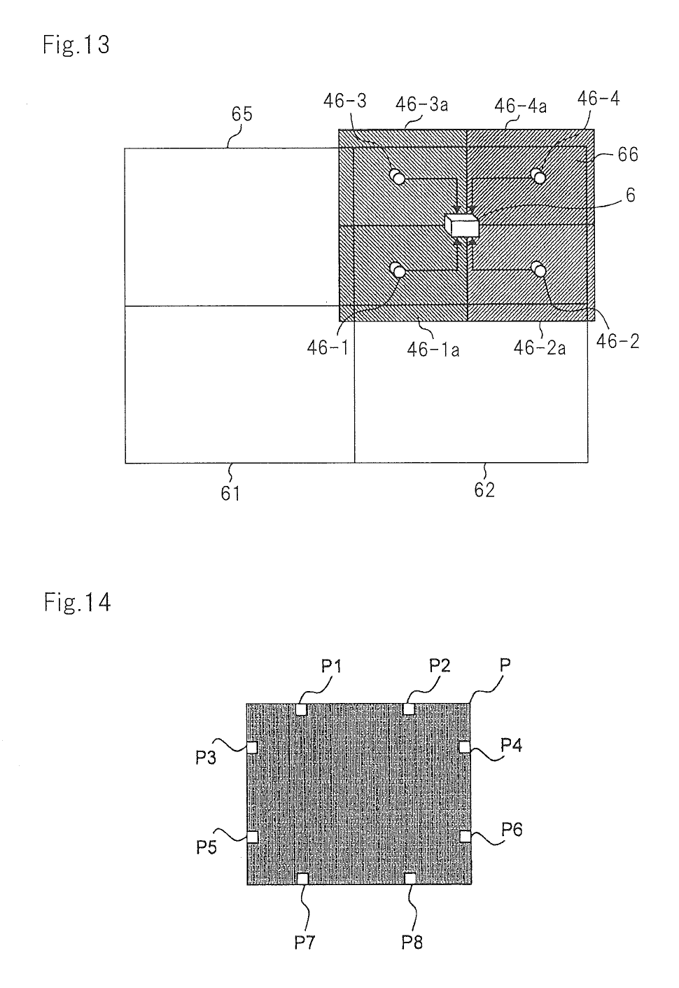

FIG. 13 gives a schematic representation of each detection range of first optical sensor 46-1, second optical sensor 46-2, third optical sensor 46-3, and third optical sensor 46-4 for the projection screen realized by projector unit 6. Screen 66 is here assumed to be partitioned into first to fourth rectangular regions.

First optical sensor 46-1 is arranged facing the first rectangular region that is located in the lower left side of screen 66, and detection range 46-1a of this optical sensor includes the first rectangular region, and the regions of the outermost peripheries of screens 61, 62, and 65 that are adjacent to the first rectangular region.

Second optical sensor 46-2 is arranged facing the second rectangular region that is located in the lower right side of screen 66, and detection range 46-2 of this optical sensor includes the second rectangular region and regions of the outermost peripheries of screens 62, 63, and 67 that are adjacent to the second rectangular region.

Third optical sensor 46-3 is arranged facing the third rectangular region that is located on the upper left side of screen 66, and detection range 46-3a of this optical sensor includes the third rectangular region and the regions of the outermost peripheries of screens 65, 69, and 70 that are adjacent to the third rectangular region.

Fourth optical sensor 46-4 is arranged facing the fourth rectangular region that is located on the upper right side of screen 66, and detection range 46-4a of this optical sensor includes the fourth rectangular region and the regions of the outermost peripheries of screens 67, 70, and 71 that are adjacent to the fourth rectangular region.

FIG. 14 shows an example of a projected image (red) that is based on an adjustment image signal. Projected image P is made up of a plurality of picture elements that are arranged in a matrix, and picture elements P1-P8 are set as the specific picture elements when acquiring differences in brightness with adjacent screens. Fluorescent light (red) having a fixed brightness is emitted at picture elements P1-P8, and fluorescent light is not emitted from picture elements other than these picture elements P1-P8.

Picture element P1 is located in approximately the center of the upper outermost periphery of the third rectangular region. Picture element P2 is located in approximately the center of the upper outermost periphery of the fourth rectangular region. Picture element P3 is located in approximately the center of the left outermost periphery of the third rectangular region. Picture element P4 is located in approximately the center of the right outermost periphery of the fourth rectangular region.

Picture element P5 is located in approximately the center of the left outermost periphery of the first rectangular region. Picture element P6 is located in approximately the center of the right outermost periphery of the second rectangular region. Picture element P7 is located in approximately the center of the lower outermost periphery of the first rectangular region. Picture element P8 is located in approximately the center of the lower outermost periphery of the second rectangular region.

The adjustment image signals of projected image P shown in FIG. 14 are supplied to projector units 1-16. Projector units 1-16 project projected image P on screens 61-76 based on the adjustment image signals.

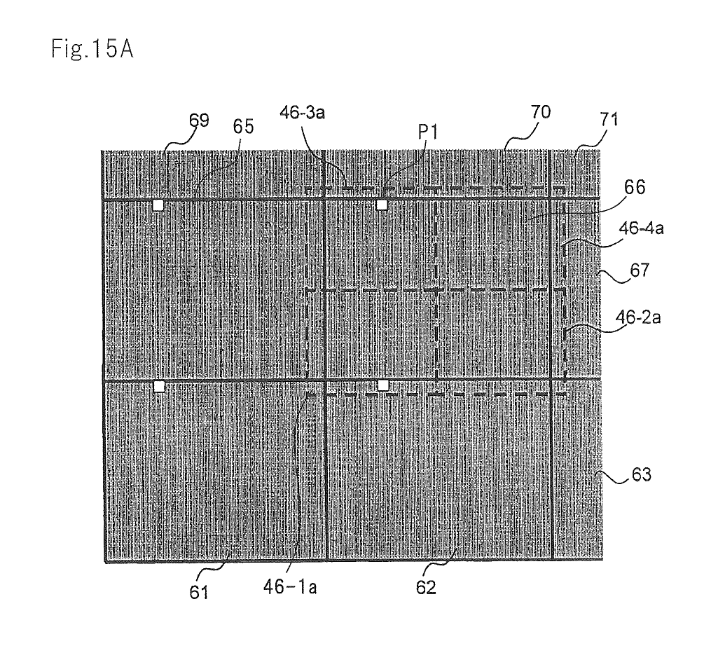

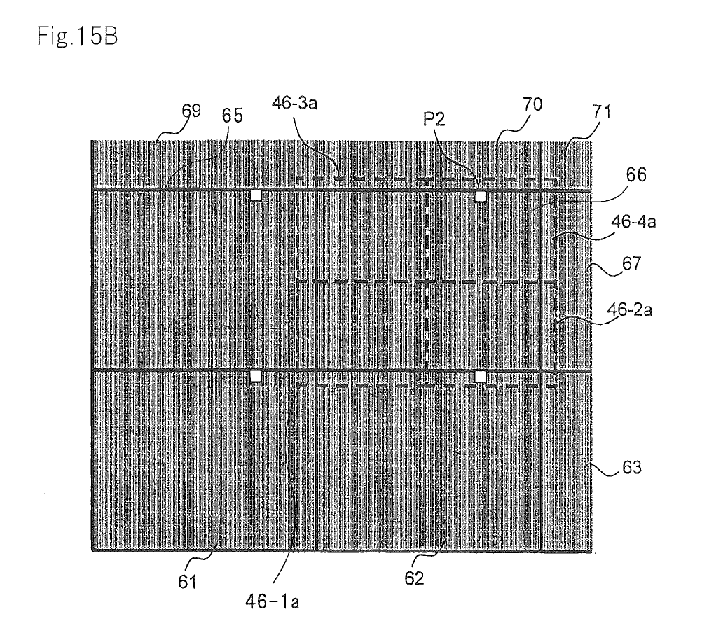

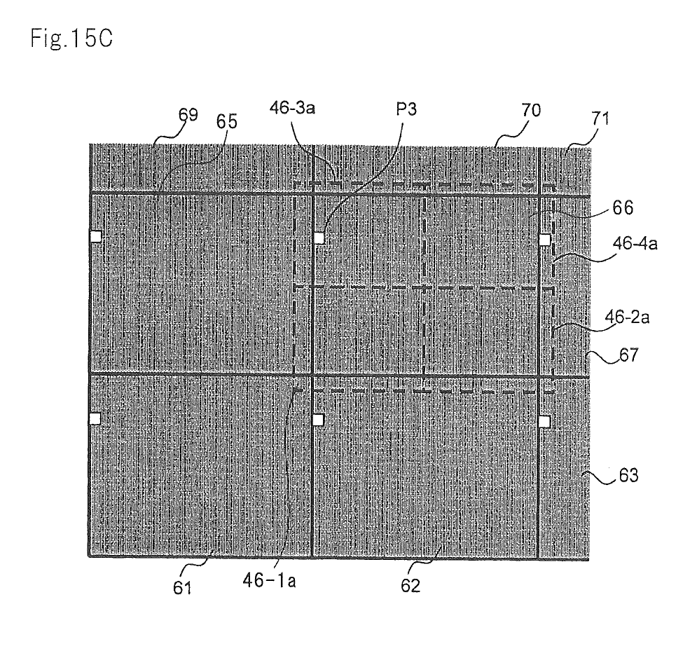

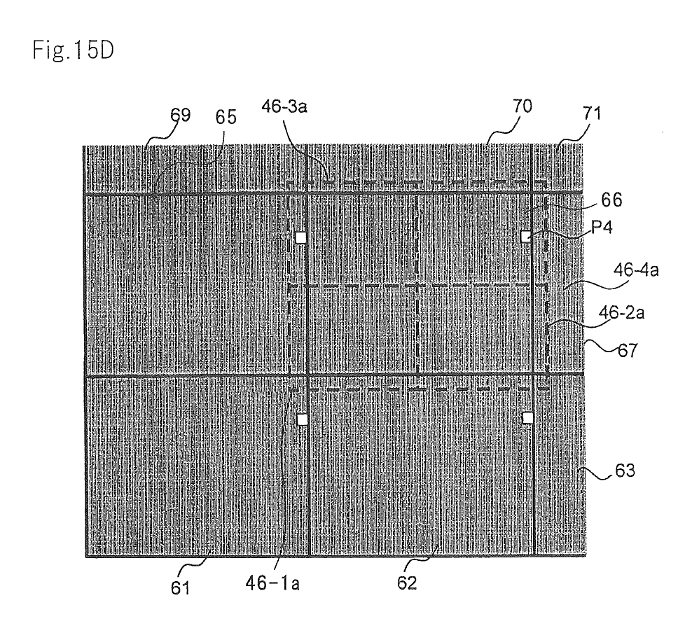

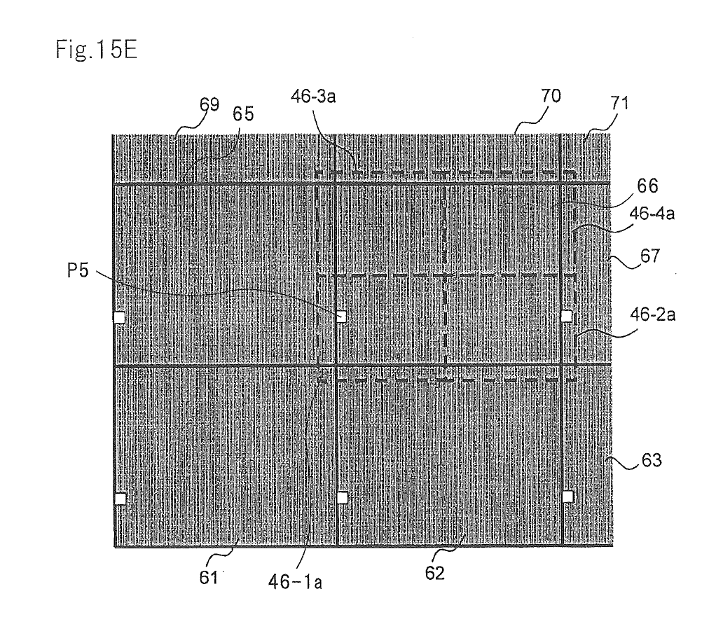

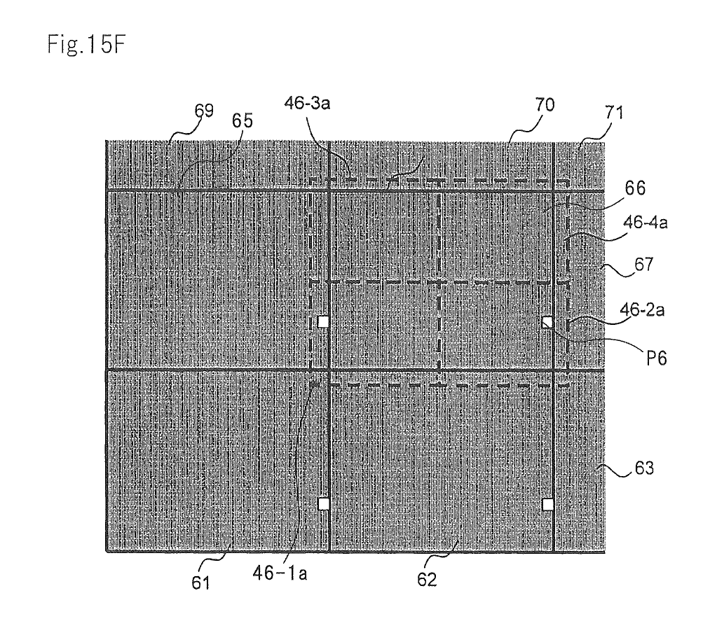

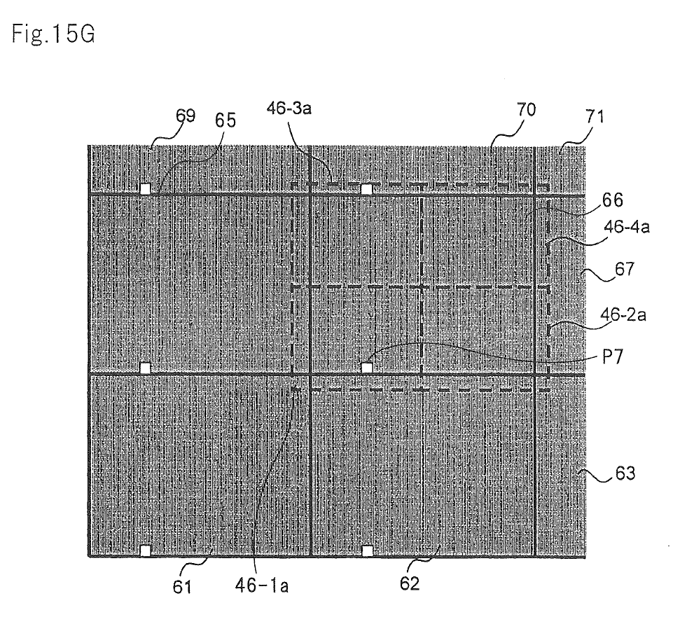

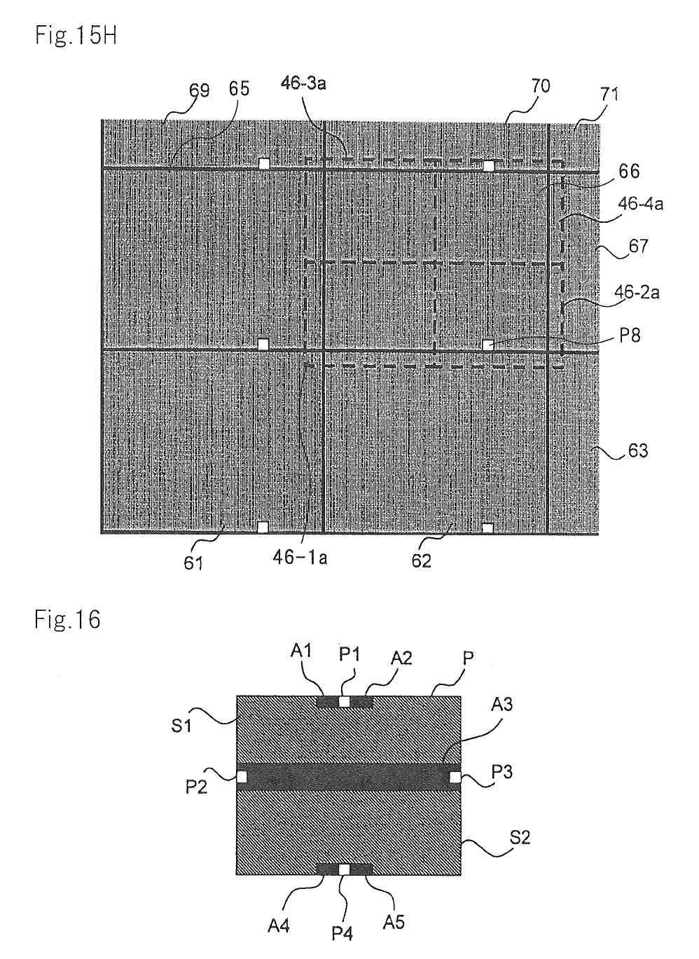

FIGS. 15A-15H give a schematic representation of the procedures for acquiring differences in brightness between the specific picture elements of the screen and adjacent screens when creating red brightness correction tables. The procedures shown in FIGS. 15A-15H are procedures executed by projector unit 6.

When scanning of the excitation light begins, picture elements P1 in screens 61, 62, 65, and 66 are lighted first, as shown in FIG. 15A. In this case, of the lighted picture elements P1 of screens 61, 62, 65, and 66, only picture element P1 of screen 62 is located within detection range 46-1a of first optical sensor 46-1, and only picture element P1 of screen 66 is located within detection range 46-3a of third optical sensor 46-3.

In the case described above, first optical sensor 46-1 detects only red fluorescent light from picture element P1 of screen 62 and supplies the result (the detection result of picture element P1 of screen 62) to projector unit 6. Third optical sensor 46-3 detects only the red fluorescent light from picture element P1 of screen 66 and supplies this result (the detection result of picture element P1 of screen 66) to projector unit 6.

After picture element P1 is irradiated, excitation light is not irradiated from the picture element immediately after picture element P1 to the picture element immediately before picture element P2.

FIG. 15B shows the state in which the excitation light irradiates picture elements P2. In this state, picture elements P2 in screens 61, 62, 65, and 66 are lighted. Of these lighted picture elements P2, only picture element P2 of screen 62 is located within detection range 46-2a of second optical sensor 46-2, and only picture element P2 of screen 66 is located within detection range 46-4a of fourth optical sensor 46-4.

In the case described above, second optical sensor 46-2 detects only the red fluorescent light from picture element P2 of screen 62 and supplies this result (the detection result of picture element P2 of screen 62) to projector unit 6. Fourth optical sensor 46-4 detects only the red fluorescent light of picture element P2 of screen 66 and supplies this result (the detection result of picture element P2 of screen 66) to projector unit 6.

After picture element P2 is irradiated, excitation light is not irradiated from the picture element immediately after picture element P2 to the picture element immediately before picture element P3.

FIG. 15C shows the state in which the excitation light irradiates picture elements P3. In this state, picture elements P3 are lighted in screens 61-63 and 65-67. Of these lighted picture elements P3, only picture element P3 of screen 66 is located within detection range 46-3a of third optical sensor 46-3, and only picture element P3 of screen 67 is located within detection range 46-4a of fourth optical sensor 46-4.

In the case described above, third optical sensor 46-2 detects only red fluorescent light from picture element P3 of screen 66 and supplies this result (the detection result of picture element P3 of screen 66) to projector unit 6. Fourth optical sensor 46-4 detects only red fluorescent light from picture element P3 of screen 67 and supplies this result (the detection result of picture element P3 of screen 67) to projector unit 6.

After picture element P3 is irradiated, excitation light is not irradiated from the picture element immediately after picture element P3 to the picture element immediately before picture element P4.

FIG. 15-D shows the state in which the excitation light irradiates picture elements P4. In this state, picture elements P4 are lighted in screens 61, 62, 65, and 66. Of these lighted picture elements P4, only picture element P4 of screen 65 is located within detection range 46-3a of third optical sensor 46-3, and only picture element P4 of screen 66 is located within detection range 46-4a of fourth optical sensor 46-4.

In the case described above, third optical sensor 46-3 detects only red fluorescent light from picture element P4 of screen 65 and supplies this result (the detection result of picture element P4 of screen 65) to projector unit 6. Fourth optical sensor 46-4 detects only red fluorescent light from picture element P4 of screen 66 and supplies this result (the detection result of picture element P4 of screen 66) to projector unit 6.

After picture element P4 is irradiated, excitation light is not irradiated from the picture element immediately after picture element P4 to the picture element immediately before picture element P5.

FIG. 15E shows the state in which the excitation light irradiates picture elements P5. In this state, picture elements P5 are lighted in screens 61-63 and 65-67. Of these lighted picture elements P5, only picture element P5 of screen 66 is located within detection range 46-1 a of first optical sensor 46-1, and only picture element P5 of screen 67 is located within detection range 46-2a of second optical sensor 46-2.

In the case described above, first optical sensor 46-1 detects only the red fluorescent light from picture element P5 of screen 66 and supplies this result (the detection result of picture element P5 of screen 66) to projector unit 6. Second optical sensor 46-2 detects only the red fluorescent light from picture element P5 of screen 67 and supplies this result (the detection result of picture element P5 of screen 67) to projector unit 6.

After picture element P5 is irradiated, excitation light is not irradiated from the picture element immediately after picture element P5 to the picture element immediately before picture element P6.

FIG. 15F shows the state in which the excitation light irradiates picture elements P6. In this state, picture elements P6 are lighted in screens 61, 62, 65, and 66. Of these lighted picture elements P6, only picture element P6 of screen 65 is located within detection range 46-1a of first optical sensor 46-1, and only picture element P6 of screen 66 is located within detection range 46-2a of second optical sensor 46-2.

In the case described above, first optical sensor 46-1 detects only the red fluorescent light from picture element P6 of screen 65 and supplies this result (the detection result of picture element P6 of screen 65) to projector unit 6. Second optical sensor 46-4 detects only the red fluorescent light from picture element P6 of screen 66 and supplies this result (the detection result of picture element P6 of screen 66) to projector unit 6.

After picture element P6 is irradiated, excitation light is not irradiated from the picture element immediately after picture element P6 to the picture element immediately before picture element P7.

FIG. 15G shows the state in which the excitation light irradiates picture elements P7. In this state, picture elements P7 are lighted in screens 61, 62, 65, 66, 69, and 70. Of these lighted picture elements P7, only picture element P7 of screen 66 is located within detection range 46-1a of first optical sensor 46-1, and only picture element P7 of screen 70 is located within detection range 46-3a of third optical sensor 46-3.

In the case described above, first optical sensor 46-1 detects only the red fluorescent light from picture element P7 of screen 66 and supplies this result (the detection result of picture element P7 of screen 66) to projector unit 6. Third optical sensor 46-3 detects only the red fluorescent light of picture element P7 of screen 70 and supplies this result (the detection result of picture element P7 of screen 70) to projector unit 6.

After picture element P7 is irradiated, excitation light is not irradiated from the picture element immediately after picture element P7 to the picture element immediately before picture element P8.

FIG. 15H shows the state in which excitation light irradiates picture elements P8. In this state, picture elements P8 are lighted in screens 61, 62, 65, 66, 69, and 70. Of these lighted picture elements P7, only picture element P8 of screen 66 is located within detection range 46-2a of second optical sensor 46-2, and only picture element P8 of screen 70 is located within detection range 46-4a of fourth optical sensor 46-4.

In the case described above, second optical sensor 46-2 detects only the red fluorescent light from picture element P8 of screen 66 and supplies this result (the detection result of picture element P8 of screen 66) to projector unit 6. Fourth optical sensor 46-4 detects only the red fluorescent light from picture element P8 of screen 70 and supplies this result (the detection result of picture element P8 of screen 70) to projector unit 6.

In projector unit 6, brightness adjustment is possible for screen 66 and each of adjacent screens 62, 65, 67, and 70 on the lower, right, left, and upper sides.

Each of the method of creating first brightness correction tables that are used between screen 66 and upper adjacent screen 70, the method of creating second brightness correction tables that are used between screen 66 and left adjacent screen 65, the method of creating third brightness correction tables that are used between screen 66 and right adjacent screen 67, and the method of creating fourth brightness correction tables that are used between screen 66 and lower adjacent screen 62 are next described.

### Method of Creating First Brightness Correction Tables

In projector unit 6, the brightness difference between picture elements P1 and P2 of screen 66 and picture elements P7 and P8 of screen 70 that is adjacent to these picture elements is used to create brightness correction tables for matching the brightness of screen 66 with the brightness of upper adjacent screen 70.

More specifically, image signal correction unit 336 acquires the difference (first brightness difference) between the brightness value of picture element P1 of screen 66 that was acquired from third optical sensor 46-3 in the state shown in FIG. 15A and the brightness value of picture element P7 of screen 70 that was acquired from third optical sensor 46-3 in the state shown in FIG. 16G. Image signal correction unit 336 further acquires the difference (the second brightness difference) between the brightness value of picture element P2 of screen 66 that was acquired from fourth optical sensor 46-4 in the state shown in FIG. 15B and the brightness value of picture element P8 of screen 70 that was acquired from fourth optical sensor 46-4 in the state shown in FIG. 15H. Image signal correction unit 336 then creates a first brightness correction table for red based on the average value of the first and second brightness differences.

In the case described above, image signal correction unit 336 may also find the difference between the average value of brightness values of picture elements P1 and P2 of screen 66 and the average value of the brightness values of picture elements P7 and P8 of screen 70 and then create the red brightness correction table based on the difference.

### Method of Creating Second Brightness Correction Tables

In projector unit 6, the brightness difference between picture elements P3 and P5 of screen 66 and picture elements P4 and P6 of screen 65 that is adjacent to these picture elements is used to create brightness correction tables for matching the brightness of screen 66 with the brightness of left-side adjacent screen 65.

More specifically, image signal correction unit 336 acquires the difference (first brightness difference) between the brightness value of picture element P3 of screen 66 that was acquired from third optical sensor 46-3 in the state shown in FIG. 15C and the brightness value of picture element P4 of screen 65 that was acquired from third optical sensor 46-3 in the state shown in FIG. 15D. Image signal correction unit 336 further acquires the difference (second brightness difference) between the brightness value of picture element P5 of screen 66 that was acquired from first optical sensor 46-1 in the state shown in FIG. 15E and the brightness value of picture element P6 of screen 65 that was acquired from first optical sensor 46-1 in the state shown in FIG. 15F. Image signal correction unit 336 then creates the second brightness correction table for red based on the average value of the first and second brightness differences.

In the case described above, image signal correction unit 336 may also find the difference between the average value of the brightness values of picture elements P3 and P5 of screen 66 and the average value of the brightness values of picture elements P4 and P6 of screen 65 and then create the second brightness correction table for red based on the difference.

### Method of Creating Third Brightness Correction Tables

In projector unit 6, the brightness differences between picture elements P4 and P6 of screen 66 and picture elements P3 and P5 of screen 67 that is adjacent to these picture elements are used to create a brightness correction table for matching the brightness of screen 66 with the brightness of screen 67 that is adjacent on the right.

More specifically, image signal correction unit 336 obtains the difference (first brightness difference) between the brightness value of picture element P4 of screen 66 that was acquired from fourth optical sensor 46-4 in the state shown in FIG. 15D and the brightness value of picture element P3 of screen 67 that was acquired from fourth optical sensor 46-4 in the state shown in FIG. 15C. Image signal correction unit 336 further obtains the difference (second brightness difference) between the brightness value of picture element P6 of screen 66 that was acquired from third optical sensor 46-3 in the state shown in FIG. 15F and the brightness value of picture element P5 of screen 67 that was acquired from second optical sensor 46-2 in the state shown in FIG. 15E. Image signal correction unit 336 then creates the third brightness correction table for red based on the average value of the first and second brightness differences.

In the case described above, image signal correction unit 336 may also find the difference between the average value of the brightness values of picture elements P4 and P5 of screen 66 and the average value of the brightness values of picture elements P3 and P5 of screen 67 and then create the third brightness correction table for red based on this difference.

### Method of Creating Fourth Brightness Correction Tables

In projector unit 6, the brightness differences between picture elements P7 and P8 of screen 66 and picture elements P1 and P2 of screen 62 that is adjacent to these picture elements are used to create a brightness correction table for matching the brightness of screen 66 with the brightness of screen 62 that is adjacent on the lower side.

More specifically, image signal correction unit 336 obtains the difference (first brightness difference) between the brightness value of picture element P7 of screen 66 that was acquired from first optical sensor 46-1 in the state shown in FIG. 15G and the brightness value of picture element P1 of screen 62 that was acquired from first optical sensor 46-1 in the state shown in FIG. 15A. Image signal correction unit 336 further obtains the difference (second brightness difference) between the brightness value of picture element P8 of screen 66 that was acquired from second optical sensor 46-2 in the state shown in FIG. 15H and the brightness value of picture element P2 of screen 62 that was acquired from second optical sensor 46-2 in the state shown in FIG. 15B. Image signal correction unit 336 then creates fourth brightness correction table for red based on the average value of the first and second brightness differences.

In the case described above, image signal correction unit 336 may find the difference between the average value of the brightness values of picture elements P7 and P8 of screen 66 and the average value of the brightness values of picture elements P1 and P2 of screen 62 and then create the fourth brightness correction table for red based on this difference.

In projector unit 6, when there is no adjacent screen (adjacent projector unit) on any of the upper, lower, left, and right sides of screen 66, image signal correction unit 336 creates the fifth brightness correction table for red such that input image signals are supplied as unchanged output without being corrected.

Main control unit 82 supplies projector unit 6 with a brightness correction table creation instruction signal instructing whether to create any of the first to fifth brightness correction tables for red. Image signal correction unit 336 creates any of the first to fifth brightness correction tables for red in accordance with the instruction signal from main control unit 82.

First to fourth brightness correction tables can also be created for green and blue in the same way as the above-described method of creating the first to fourth brightness correction tables for red. Image signal correction unit 336 creates any of the first to fourth brightness correction tables for each of green and blue in accordance with an instruction from main control unit 82.

In projector units 1-5 and 7-16 as well, any of first to fifth brightness correction tables can also be created in accordance with a brightness correction table creation instruction signal from main control unit 82 regarding each of the colors red, green, and blue by procedures similar to those of projector unit 6.

In the multi-projection display of the present exemplary embodiment, each of projector units 1-16 is capable of brightness adjustment with each adjacent projector unit on the upper, lower, left, and right sides. Main control unit 82 takes one projector unit among projector units 1-16 as a reference and causes the reference projector unit to create the fifth brightness correction tables of each color. Main control unit 82 further causes the remaining projector units to create any of the first to fourth brightness correction tables in accordance with the arrangement of each of the projector units.

Projector units 1-16 carry out the adjustment processes simultaneously, and if these adjustment processes are repeated several times, the brightness of the projected image of each color of projector units 1-16 can be substantially matched, and a projected image of uniform brightness can be obtained over the entire display screen 78. Main control unit 82 causes projector units 1-16 to carry out the adjustment process a predetermined number of times.

The multi-projection display of the present exemplary embodiment exhibits the same action and effect as the first and second exemplary embodiments. In particular, the present exemplary embodiment enables the creation of brightness correction tables between the projector unit and a projector unit that is adjacent on any of the upper, lower, left, and right sides and therefore decreases the number of times that brightness adjustment is carried out compared to the second exemplary embodiment.

The configuration and operations of the multi-projection display of the present exemplary embodiment can be modified as appropriate.

For example, the adjustment image shown in FIG. 10 can be used in place of the adjustment image shown in FIG. 14. In this case, the detection range of the first optical sensor is set to a region in the vicinity of the first side in which picture element P1 is located, the detection range of the second optical sensor is set to a region in the vicinity of the second side in which picture element P2 is located, the detection range of the third optical sensor is set to a region in the vicinity of the third side in which picture element P3 is located, and the detection range of the fourth optical sensor is set to a region in the vicinity of the fourth side in which picture element P4 is located.

In the case described above, when there is an adjacent projector unit on the upper side of the projector unit, the difference between the brightness value of picture element P1 of the screen of the projector unit and the brightness value of picture element P4 of the adjacent screen is acquired from the first optical sensor and a brightness correction table is created based on this brightness difference.

When there is an adjacent projector unit on the left side of the projector unit, the difference between the brightness value of picture element P2 of the screen of the projector unit and the brightness value of picture element P3 of the adjacent screen is acquired from the second optical sensor and a brightness correction table is created based on this brightness difference.

When there is an adjacent projector unit on the right side of the projector unit, the difference between the brightness value of picture element P3 of the screen of the projector unit and the brightness value of picture element P2 of the adjacent screen is acquired from the third optical sensor and a brightness correction table is created based on this brightness difference.

When there is an adjacent projector unit on the lower side of a projector unit, the difference between the brightness value of picture element P4 of the screen of the projector unit and the brightness value of picture element P1 of the adjacent screen is acquired from the fourth optical sensor and the brightness correction table is created based on this brightness difference.

In the case described above, a plurality of each of first sets of picture elements P1 and picture elements P4 and second sets of picture elements P2 and picture elements P3 may be provided. When there is an adjacent projector unit on the upper side or lower side of the projector unit in this case, the brightness differences between picture elements P1 and P4 are found for each first set and a brightness correction table is created based on the average value of these brightness differences. When there is an adjacent projector unit on the left side or right side of the projector unit, brightness differences between picture elements P2 and P3 are found for each second set and a brightness correction table is created based on the average value of these brightness differences. In this way, the brightness differences between adjacent picture elements in screen boundary portions of the screen of the projector unit and an adjacent screen can be reduced, whereby seams become more difficult to perceive.

The multi-projection displays of each exemplary embodiment described hereinabove are merely examples of the present invention, and the configuration and operation of these exemplary embodiments can be modified within a scope that does not depart from the gist of the invention that will be clear to one of ordinary skill in the art.

For example, main control unit 82 in the first to third exemplary embodiments may place picture elements around the specific picture element of an adjustment image in an unlighted state.

Main control unit 82 may supply, as an adjustment image signal to each of projector units 1-16, image signals in which the picture element region other than the specific picture elements and picture elements that surround the specific picture elements (picture elements in the unlighted state) has been rewritten to signals of picture elements that face the above-described picture element region of the image based on input image signals (divided image signals).

FIG. 16 gives a schematic representation of an example of an image in which picture elements around the specific picture element of the adjustment image shown in FIG. 14 are placed in the unlighted state.

Referring to FIG. 16, regions A1 and A2 before and after picture element P1 in the scanning direction are made up of picture elements in the unlighted state. The number of picture elements of region A1 is equal to the number of picture elements of region A2. The number of picture elements of regions A1 and A2 is determined based on the synchronization shift in a horizontal direction among projector units 1-16.

Region A3 includes the scanning line that contains picture elements P2 and P3 and the two scanning lines adjacent to both sides of the scanning line. Picture elements other than picture elements P2 and P3 of region A3 are placed in the unlighted state.

Regions A4 and AS before and after picture element P4 in the scanning direction are made up of picture elements in the unlighted state. The number of picture elements of region A4 is the same as the number of picture elements of region A5. The number of picture elements of regions A4 and A5 is determined based on the synchronization shift in the horizontal direction among projector units 1-16.

Main control unit 82 generates, as adjustment image signals, image signals in which each picture element of regions S1 and S2 other than picture elements P1-P4 and picture elements in the unlighted state of regions A1-A5 is rewritten by the signal of the picture element that corresponds to the image based on the input image signals (divided image signals).

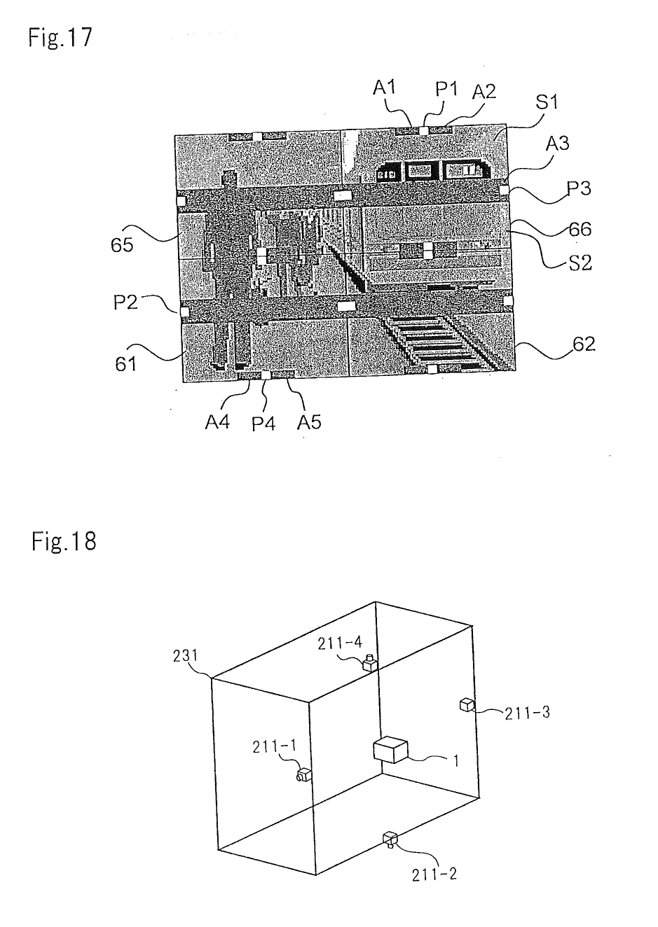

FIG. 17 shows an example of such an adjustment image signal.

FIG. 17 gives a schematic representation of an adjustment image based on an adjustment image signal and that is projected by projector units 1, 2, 5, and 6. Projected image P shown in

FIG. 16 is displayed on each of screens 61, 62, 65, and 66. In screen 61, an image that is based on first divided image signals is displayed in regions S1 and S2. In screen 62, an image that is based on second divided image signals is displayed in regions S1 and S2. In screen 65, an image that is based on fifth divided image signals is displayed in regions S1 and S2. In screen 66, an image based on sixth divided image signals is displayed in regions S1 and S2.

As described hereinabove, in other projector units 3, 4, and 7-16, projected image P shown in FIG. 16 is displayed, and an image based on corresponding divided image signals is displayed in regions S1 and S2.

According to the above-described configuration, brightness correction tables for each color can be produced while images based on first to sixteenth divided image signals are displayed in projector units 1-16.

In addition, in the first to third exemplary embodiments, display screen 78 may be a screen having a diffusion layer that diffuses laser light of each of the colors red, green, and blue. In this case, each of projector units 1-16 is equipped with a laser light source that emits laser light of each color and is equipped with a projection unit shown in FIG. 4 for each laser light source.

In the first to third exemplary embodiments, moreover, each of projector units 1-16 may be equipped with an adjacent information acquisition unit that detects the absence or presence of an adjacent projector unit.

FIG. 18 shows an example of an adjacent information acquisition unit. Referring to FIG. 18, mechanical switches 211-1-211-4 are provided on case 231 that accommodates projector unit 1. The adjacent information acquisition unit is made up from the mechanical switches 211-1-211-4.

Mechanical switch 211-1 is arranged on the inner side of the left side surface and a protrusion projects to the outside from this surface. By pressing the upper end of the protrusion down as far as the side surface, the switch enters the ON state and a first detection signal indicating this state is supplied as output.

Mechanical switch 211-2 is arranged on the inner side of the lower surface with a protrusion projecting to the outside from this surface. By pressing the protrusion down such that the upper end of the protrusion is pressed as far as the lower surface, the switch enters the ON state and a second detection signal indicating this state is supplied as output.

Mechanical switch 211-3 is arranged on the inner side of the right side surface with a protrusion that projects to the outside from this surface. By pressing the protrusion down such that the upper end of the protrusion is pressed as far as the side surface, the switch enters the ON state and a third detection signal indicating this state is supplied as output.

Mechanical switch 211-4 is arranged on the inner side of the upper surface with a protrusion that projects outside this surface. By pressing the protrusion down such that the upper end of the protrusion is pressed as far as the upper surface, the switch enters the ON state and a fourth detection signal indicating this state is supplied as output.

The first to fourth detection signals are supplied to image signal correction unit 331. Image signal correction unit 331 detects the presence or absence of an adjacent projector unit based on the first to fourth detection signals.

Adjacent information acquisition units with the same configuration as shown in FIG. 18 are also provided in other projector units 2-16.

Although the present invention has been described with reference to the exemplary embodiments, the present invention is not limited to the exemplary embodiments described hereinabove. The configuration and operation of the present invention are open to various modifications within a scope that does not depart from the gist of the present invention that will be clear to one of ordinary skill in the art.

This application claims the benefits of priority based on Japanese Patent Application No. 2011-046795 for which application was submitted on Mar. 3, 2011 and incorporates by citation all of the disclosures of that application.

1. A multi-projection display that includes a plurality of projector units that project onto a display screen images based on input image signals by each scanning with an optical beam and that joins together the projected images that are projected by each projector unit to display them as one image; said multi-projection display comprising:
a plurality of optical sensors that are provided in each of said projector units, each of said optical sensors detecting light from a plurality of specific picture elements that display the projected image of each of said projector units on the edges of a display region; and
a main control unit that causes adjustment images for adjusting brightness to be displayed by each of said projector units to light said plurality of specific picture elements at a predetermined brightness and that establishes vertical synchronization of the display of said adjustment images of each of the projector units;
wherein each of said projector units includes an image signal correction unit that acquires by said optical sensor brightness values of said plurality of specific picture elements when said adjustment image is displayed, creates a brightness correction table for matching the brightness of said projected image that is projected by the projector unit with the brightness of said projected image that is projected by another projector unit based on the difference of the acquired brightness values, and then uses the brightness correction table to correct the brightness of each picture element of the image based on said input image signals.

2. The multi-projection display as set forth in claim 1, wherein said image signal correction unit, when another projector unit is not arranged adjacent to said projector unit, in place of said brightness correction table, creates another brightness correction table that supplies said input image signals without alteration.

3. The multi-projection display as set forth in claim 1, wherein:
a first projector unit that is adjacent to said projector unit in a first direction and a second projector unit that is adjacent to said projector unit in a second direction that is orthogonal to said first direction are present as said other projector units;
said plurality of specific picture elements include first and second specific picture elements that are mutually adjacent and arranged on the edges of the display regions of each of the projected image of said projector unit and the projected image of said first projector unit, and third and fourth specific picture elements that are mutually adjacent and arranged on the edges of display regions of each of the projected image of said projector unit and the projected image of said second projector unit; and
said image signal correction unit:
when said first projector unit is selected as the object of brightness adjustment, acquires from said optical sensor brightness values of said first and second specific picture elements when said adjustment image is displayed and creates said brightness collection table based on the difference between the brightness values that were acquired; and
when said second projector unit is selected as the object of brightness adjustment, acquires from said optical sensor brightness values of said third and fourth specific picture elements when said adjustment image is displayed and creates said brightness correction table based on the difference between the brightness values that were acquired.

4. The multi-projection display as set forth in claim 3, wherein a plurality exists of each of first sets of said first and second specific picture elements and second sets of said third and fourth specific picture elements; and said image signal correction unit:
when said first projector unit is selected as the object of brightness adjustment, acquires said brightness differences of said first and second specific picture elements for each of said first sets and creates said brightness correction table based on the average value of said brightness differences; and
when said second projector unit is selected as the object of brightness adjustment, acquires said brightness differences between said third and fourth specific picture elements for each of said second sets and creates said brightness correction table based on the average value of the brightness differences.

5. The multi-projection display as set forth in claim 3, wherein:
a third projector unit that is adjacent to said projector unit in a third direction that is opposite to said first direction and a fourth projector unit that is adjacent to said projector unit in a fourth direction that is opposite to said second direction further exist as said other projector units;
said plurality of specific picture elements further include: fifth and sixth specific picture elements that are mutually adjacent and that are arranged on the edges of display regions of each of the projected image of said projector unit and the projected image of said third projector unit, and seventh and eighth specific picture elements that are mutually adjacent and that are arranged on the edges of display regions of each of the projected image of said projector unit and the projected image of said fourth projector unit; and
said image signal correction unit:
when said third projector unit is selected as the object of brightness adjustment, acquires from said optical sensor brightness values of said fifth and sixth specific picture elements when said adjustment image is displayed and creates said brightness correction table based on the difference between the brightness values that were acquired; and
when said fourth projector unit is selected as the object of brightness adjustment, acquires from said optical sensor brightness values of said seventh and eighth specific picture elements when said adjustment image is displayed and creates said brightness correction table based on the difference between the brightness values that were acquired.

6. The multi-projection display as set forth in claim 5, wherein:
a plurality exists of each of third sets of said fifth and sixth specific picture elements and fourth sets of said seventh and eighth specific picture elements;
said image signal correction unit:
when said third projector unit is selected as the object of brightness adjustment, acquires said brightness differences between said fifth and sixth specific picture elements for each of said third sets and creates said brightness correction table based on the average value of the brightness differences;
when said fourth projector unit is selected as the object of brightness adjustment; acquires said brightness differences between said seventh and eighth specific picture elements for each of said fourth sets and creates said brightness correction table based on the average value of the brightness differences.

7. The multi-projection display as set forth in claim 1, wherein:
said main control unit transmits identification information that indicates the projector unit that is to be the object of brightness adjustment to each of said projector units; and
said image signal correction unit selects the object of brightness adjustment from among said projector units based on said identification information from said main control unit.

8. The multi-projection display as set forth in claim 1, wherein said image signal correction unit detects projector units that are adjacent to the particular projector unit and selects by a predetermined procedure the object of brightness adjustment from the projector units that were detected.

9. The multi-projection display as set forth in claim 1, wherein:
each of said plurality of optical sensors detects each of colors red, green, and blue;
each of said projector units is configured to project, as said projected images on said display screen, images corresponding to each of said colors in time divisions; and
said image signal correction unit acquires from said optical sensors the brightness differences of said specific picture elements for each of said colors, and creates brightness correction tables for each of said colors based on the brightness differences that were acquired.

10. The multi-projection display as set forth in claim 1, wherein said main control unit supplies to each of said projector units image signals in which, when each of said projector units displays said adjustment image, picture elements around said plurality of specific picture element are set to brightness that corresponds to black.

11. The multi-projection display as set forth in claim 10, wherein said main control unit supplies to each of said projector units image signals in which, when each of said projector units displays said adjustment image, the signals of picture elements other than said plurality of specific picture elements and picture elements around these specific picture elements are rewritten by signals of picture elements that face the image based on said input image signals.

12. The multi-projection display as set forth in claim 1, wherein each of said projector units includes a resonant scanning mirror that scans an optical beam.

13. The multi-projection display as set forth in claim 1, wherein each of said plurality of optical sensors includes at least one photodiode.

14. A brightness adjustment method that is carried out in a multi-projection display, wherein said multi-projection display includes a plurality of projector units that project onto a display screen images based on input image signals by each scanning with an optical beam and joins together the projected images that are projected by each projector unit to display them as one image, said brightness adjustment method comprising:
providing in each of said projector units an optical sensor that detects light from a plurality of specific picture elements that display a projected image of each of said projector units on edges of display regions;
causing, by a main control unit, adjustment images for adjusting brightness to be displayed by each of said projector units to light said plurality of specific picture elements at a predetermined brightness and establishing, by the main control unit, vertical synchronization of the display of said adjustment images of each of said projector units; and
acquiring, by each of the projector units, brightness values of said plurality of specific picture elements by said optical sensor when displaying said adjustment images, based on the differences of the acquired brightness values, creating, by each of the projector units, a brightness correction table for matching the brightness of said projected image that is projected by the projector unit with the brightness of said projected image that is projected by another projector unit, and then using, by each of the projector units, the brightness correction table to correct the brightness of each picture element of an image based on said input image signals.
